(19) United States
(12) Patent Application Publication
(10) Pub. No.: US 2003/0177501 A1
(43) Pub. Date: Sep. 18, 2003

(54) Electronic apparatus, software program, program providing apparatus, and storage medium

(76) Inventors: Naomasa Takahashi, Chiba (JP); Hirotaka Kondo, Kanagawa (JP)

Correspondence Address: FROMMER LAWRENCE & HAUG LLP, 745 FIFTH AVENUE, NEW YORK, NY, 10151, US

(21) Appl. No.: 10/387,158

(22) Filed: Mar. 12, 2003

(30) Foreign Application Priority Data
Mar. 14, 2002 (JP) P2002-070733
May 14, 2002 (JP) P2002-139164

(51) Int. Cl. G06F 3/00; G06F 13/00; H04N 5/445

(52) U.S. Cl. 725/110; 725/112; 725/136; 345/760; 725/37; 725/141

(57) ABSTRACT

A display information program for laying out the screen of a television set includes a part which defines a plurality of display areas and lays out the display areas and a part which defines a external information source at which information to be displayed in the defined display areas is originated and allows other information to be attached thereto. The displaying of information from a particular external information source is defined. Using the rule of URI, the external information is laid out on a display screen with layout freedom.

### BACKGROUND OF THE INVENTION

1. Field of the Invention

The present invention relates to an electronic apparatus such as a television set, PDA (Personal Digital Assistant), camcorder, etc. The present invention also relates to a software program for use in an electronic apparatus, program providing apparatus which provides the electronic apparatus with the software program, a storage medium such as CD (Compact Disk), floppy disk, or RAM (Random Access Memory) storing such software program.

2. Description of the Related Art

An electronic apparatus, such as a television set, having a display receives various video inputs as a variety of pieces of information is available today.

The layout of a display screen is typically fixed. For example, typical layouts are a P-out-P layout in which two screens, juxtaposed to each other, present video information from two respective apparatuses, and a P-in-P layout in which video information from one apparatus is presented in one screen within another screen.

The PDA and the camcorder are subject to restrictions in a display position of an image in the display screen thereof. For example, in a PDA having a camera function, a video and a text associated therewith such as a caption are not freely moved in position.

With broadband techniques in widespread use, contents are freely available over a network. It is not a good choice to present a diversity of contents in a screen or a display having a preset and fixed size. There is a need for laying out images on a display screen on a television set of the user with layout freedom.

To overcome this drawback, SMIL (Synchronized Multimedia Integration Language) standardized by the W3C (World Wide Web Consortium, an institution for formulating standards relating to web techniques) may be used. As of Aug. 16, 2001, SMIL 2.0 is recommended.

XML (extensible Markup Language) is an important markup language which is used to exchange and distribute documents and data over the Internet and may become a technical standard. The feature of the XML is that a tag is defined by the XML itself, that each tag conveys the meaning of the content of the tag, and that the XML is extendable.

The SMIL integrates multimedia data such as a still image, moving image, and voice, and achieves synchronization with the Web (World Wide Web) page.

Actually expressed using the SMIL is a method which is intended to identify data over the Web and thus to overcome a problem of URL (Uniform Resource Locator). A description of URIs (Uniform Resource Identifiers) including the URL and new URN (Uniform Resource Name) is permitted in the SMIL.

Specifically, the SMIL is limited to a description present in a file or a description designated by the URL over the Web. The URL is a standard which describes a procedure to access information present over the Internet and a location of the information. The URL describes a protocol in use, and locations of a server and a file, and designates data using a name unique thereto.

A video or still image may be stored in a video input device such as a gaming machine, or a non-mobile VCR, an external memory such as a memory stick, SD (Secure Digital) memory card, CompactFlash (Trade Name), smart media, or MMC (Multimedia Card). To present such video or still image on a display screen of a display, the video or still image must be converted into a file which can be recognized by an electronic apparatus arranged in the display. It is thus difficult to lay out information such as moving images on the display screen with layout freedom.

### SUMMARY OF THE INVENTION

Accordingly, it is an object of the present invention to provide an electronic apparatus which presents information fed from the outside world on a desired location within the screen of a display.

It is another object of the present invention to provide a software program for use in the electronic apparatus, a program providing apparatus providing the electronic apparatus with such program, and a storage medium storing such program.

In a first aspect, the present invention relates to an electronic apparatus and includes a display for displaying an image, an interface for inputting information from the outside world, and a storage unit for storing a software program in which display information, containing the information input through the interface from the outside world, to be displayed on the display, and layout information relating to a layout of each piece of information are described, and a unit for causing the display to present each piece of information in accordance with the display information and the layout information described in the software program.

In accordance with the present invention, the software program contains the display information indicating the information to be displayed on the display and the information input through the interface. Each piece of information is thus displayed on the display in accordance with the display information and the layout information described in the software program. The information input from the outside world is presented on the display to a desired location thereon.

In a preferred embodiment, the electronic apparatus includes a plurality of the interfaces, wherein the display information of the stored software program contains interface identification information for identifying one of the plurality of interfaces. The display information of the software program thus identifies one of the plurality of interfaces, and predetermined external information is presented in a desired location on the display.

In another preferred embodiment, information input through each of a plurality of channels from the outside world is input through the interface, and the display information of the stored software program contains channel identification information for identifying one of the plurality of channels. Using the software program, one of the plurality of channels is identified. For example, as for BS (Broadcasting Satellite) broadcasting, one channel such as BS23 may be identified, and information input through this channel may be laid out on a screen.

In yet another preferred embodiment, a plurality of types of information are input through the interface, wherein the display information of the stored software program contains priority information for selecting one of the plurality of types of information with priority. One of the plurality of types of information is thus selected with priority, and laid out on the screen.

In a further preferred embodiment, the storage unit stores a plurality of software programs, and the electronic apparatus includes a selector which selects one of the plurality of software programs stored in the storage unit to cause the display to display an image in accordance with the selected software program. Each of the software programs is freely selected to achieve a desired screen layout at a high level of customization.

In a still further embodiment, the electronic apparatus preferably further includes a selector for selecting one of the plurality of software programs, and the storage unit stores the one selected software program as a software program to be displayed. Upon receiving the program to be displayed from the electronic apparatus of the present invention, the display presents a screen laid out in a desired fashion based on the program. For example, with a compact and handy electronic apparatus and separate display of the present invention, a screen laid out in a desired fashion is presented based on one of numerous software programs.

In a second aspect, the present invention relates to an electronic apparatus and includes a display for displaying an image, a storage unit storing a plurality of software programs, each software program in which display information indicating information to be displayed on the display and layout information relating to a layout of each piece of information are described, and a selector for selecting one of the plurality of stored software programs, and a unit for causing the display to display an image responsive to the selected program.

In accordance with the present invention, the plurality of software programs containing the display information indicating information to be displayed on the display and the layout information relating to a layout of each piece of information are stored, and one of the plurality of stored software programs is selected. Each of the software programs is freely selected to achieve a desired screen layout at a high level of customization.

In one preferred embodiment, the display information of the stored software program contains interface identification information for identifying one of the plurality of interfaces. The display information of the software program thus identifies one of the plurality of interfaces, and predetermined external information is presented in a desired location on the display.

In another preferred embodiment, information input through each of a plurality of channels from the outside world is input through the interface, and the display information of the stored software program contains channel identification information for identifying one of the plurality of channels. Using the software program, each of the plurality of channels is identified. For example, as for BS broadcasting, one channel such as BS23 may be identified, and information input through this channel may be laid out on a screen.

In yet another preferred embodiment, a plurality of types of information are input through the interface, and the display information of the stored software program contains priority information for selecting one of the plurality of types of information with priority. One of the plurality of types of information is thus selected with priority, and laid out on the screen.

In a third aspect, the present invention relates to and an electronic apparatus and includes a display for displaying an image, a selector selecting one of a plurality of software programs in which display information indicating information to be displayed on the display and layout information relating to a layout of each piece of information are described, and a unit for causing the display to display an image responsive to the selected program.

The present invention includes the selector for selecting one of the plurality of software programs in which display information indicating information to be displayed on the display and layout information relating to a layout of each piece of information are described, and a unit for causing the display to display an image responsive to the selected software program. Each of the software programs is freely selected to present a desired screen layout on the display screen at a high level of customization.

A plurality of programs may be stored in another electronic apparatus, and a desired program may be selected from these programs. Any one of numerous programs may be used on a mobile, compact and handy electronic apparatus that presents corresponding images.

In one preferred embodiment, the display information of the software program contains interface identification information for identifying one of the plurality of interfaces. The display information of the software program thus identifies one of the plurality of interfaces, and predetermined external information is presented in a desired location on the display screen.

In another preferred embodiment, information input through each of a plurality of channels from the outside world is input through the interface, and the display information of the software program contains channel identification information for identifying one of the plurality of channels. Using the software program, each of the plurality of channels is identified. For example, as for BS broadcasting, one channel such as BS23 may be identified, and information input through this channel may be laid out on the display screen.

In yet another preferred embodiment, a plurality of types of information are input through the interface, and the display information of the software program contains priority information for selecting one of the plurality of types of information with priority. The one of the plurality of types of information is thus selected with priority, and laid out on the display screen.

In a fourth aspect, the present invention relates to a software program in which, at least, first display information indicating information to be displayed on a display of an electronic apparatus and first layout information relating to each piece of information are described. The software program includes a definition of second display information functioning as a trigger for selecting an interface for inputting information from outside the electronic apparatus and for displaying, on the display, the information input through the selected interface, and a definition of second layout information relating to the information input through the interface.

In accordance with the present invention, the software program defines the second display information for displaying, on the display, the information input through the selected interface, and the second layout information. The second display information defines the content of a specific process. For example, a program based on an XML document freely defines the scheme of a URI. The information input through the selected interface is laid out on the display with layout freedom.

In a preferred embodiment, the second display information contains a definition of interface identification information for identifying one of the plurality of interfaces. The program thus identifies the interface, such as a network, BS tuner, or video input terminal, and the information input through one of these interfaces is laid out as screen information.

In another preferred embodiment, the second display information contains a definition of channel identification information for identifying one of the plurality of channels. The program identifies one of the plurality of channels. The information input through that channel is laid out as the screen information.

In yet another preferred embodiment, the second display information contains a definition of priority information for selecting one of the plurality of types of information with priority. One of the plurality of types of information is thus selected with priority, and laid out on the screen.

In a fifth aspect, the present invention relates to a program providing apparatus for providing a software program to a requester through a transmission line in response to a request through the transmission. The software program, in which, at least, first display information indicating information to be displayed on a display of an electronic apparatus and first layout information relating to each piece of information are described, includes a definition of second display information functioning as a trigger for selecting an interface for inputting information from outside the electronic apparatus and for displaying, on the display, the information input through the selected interface, and a definition of second layout information relating to the information input through the interface.

In accordance with the present invention, the program providing apparatus provides the software program to the requester through the transmission line in response to the request. With the program provided by the program providing apparatus, video information such as gaming information input to an apparatus such as a personal computer are laid out on a display screen with layout freedom.

In a sixth aspect, the present invention relates to a storage medium storing a software program in which, at least, descriptions of first display information indicating information to be displayed on a display of an electronic apparatus and first layout information relating to each piece of information are described. The software program includes a definition of second display information functioning as a trigger for selecting an interface for inputting information from outside the electronic apparatus and for displaying, on the display, the information input through the selected interface, and a definition of second layout information relating to the information input through the interface.

### BRIEF DESCRIPTION OF THE DRAWINGS

FIG. 1 is a block diagram of a system of a television set in accordance with a first embodiment of the present invention;

FIG. 2 is a block diagram of a controller illustrated in FIG. 1;

FIG. 3 is a diagram of a software stack in accordance with the first embodiment of the present invention;

FIG. 4 shows a display information program containing a description of videoinput in accordance with the first embodiment of the present invention;

FIG. 5 shows a display information program for adjusting contrast in accordance with a second embodiment of the present invention;

FIG. 6 shows a screen presenting a video input in accordance with the first embodiment of the present invention;

FIG. 7 is a flow diagram of the first embodiment of the present invention;

FIG. 8 shows a conventional description of the SMIL;

FIG. 9 shows apparatuses connected to the television set of the first embodiment of the present invention;

FIG. 10 shows a P-out-P layout of the television screen of a conventional art;

FIG. 11 shows a P-in-P layout of the television screen of a conventional art;

FIG. 12 is a flow diagram of the second embodiment of the present invention;

FIG. 13 shows a adjustment screen for contrast, etc., in accordance with the second embodiment of the present invention;

FIG. 14 is a block diagram of a PDA in accordance with a third embodiment of the present invention;

FIG. 15 is an external view of the PDA of the third embodiment of the present invention;

FIG. 16 is a block diagram of a program providing server which provides a display information program in accordance with a fourth embodiment of the present invention;

FIG. 17 is a block diagram showing a system of television set in accordance with a fifth embodiment of the present invention;

FIG. 18 is a block diagram of a controller of FIG. 17;

FIG. 19 is a diagram of a software stack of a display screen layout in accordance with the fifth embodiment of the present invention;

FIG. 20 shows a display information program of a screen layout 1 in accordance with the fifth embodiment of the present invention;

FIG. 21 shows a display information program of a screen layout 2 in accordance with the fifth embodiment of the present invention;

FIG. 22 shows a display information program of a screen layout 3 in accordance with the fifth embodiment of the present invention;

FIG. 23 shows a screen presenting a video input in accordance with the fifth embodiment of the present invention;

FIG. 24 shows screen layouts 1 through 6 in accordance with the fifth embodiment of the present invention;

FIG. 25 is a flow diagram showing the fifth embodiment of the present invention;

FIG. 26 shows the relationship between a screen layout and a screen layout selector in accordance with the fifth embodiment of the present invention;

FIG. 27 shows apparatuses connected to the television set of the fifth embodiment of the present invention;

FIG. 28 shows a screen layout responsive to a remote controller of the television set in accordance with the fifth embodiment of the present invention;

FIG. 29 is a block diagram of a PDA in accordance with a sixth embodiment of the present invention;

FIG. 30 is an external view of the PDA in accordance with the sixth embodiment of the present invention;

FIG. 31 shows the window outline of screen layouts in accordance with the sixth embodiment of the present invention;

FIG. 32 is an external view of a mobile telephone of the sixth embodiment of the present invention; and

FIG. 33 is a block diagram of a server which provides a display information program to a requesting terminal through a network in accordance with a seventh embodiment of the present invention.

### DESCRIPTION OF THE PREFERRED EMBODIMENTS

The present invention is now applied to a television set.

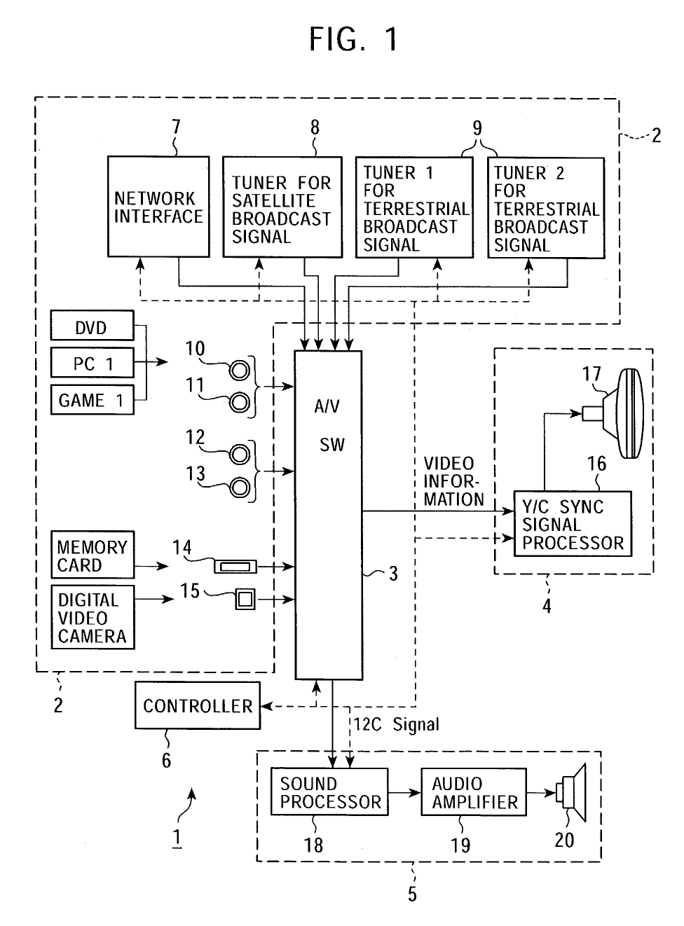

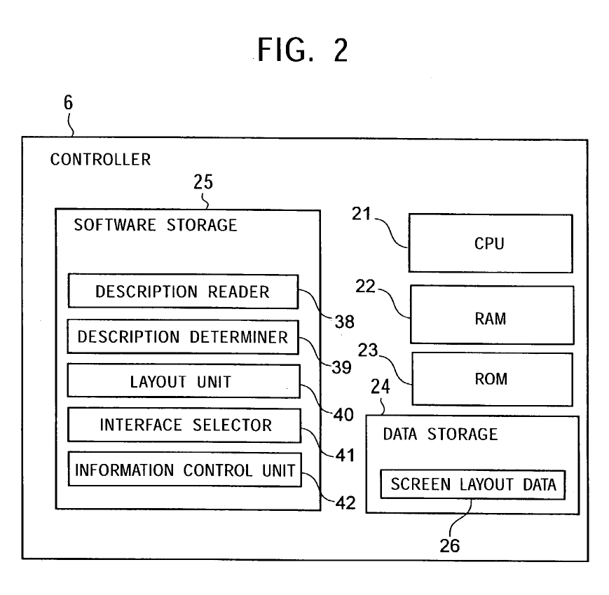

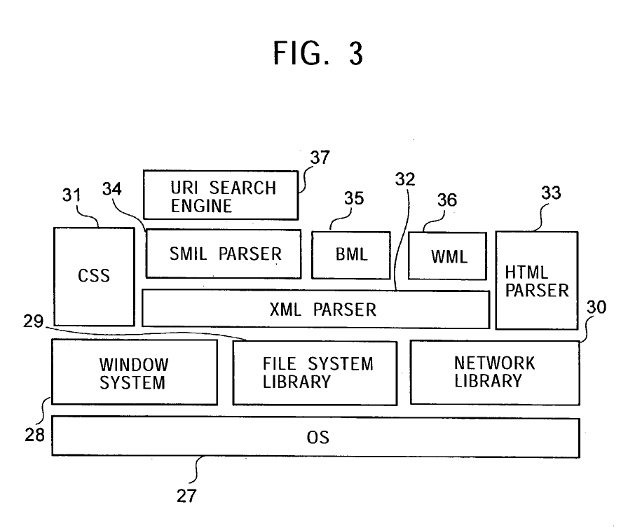

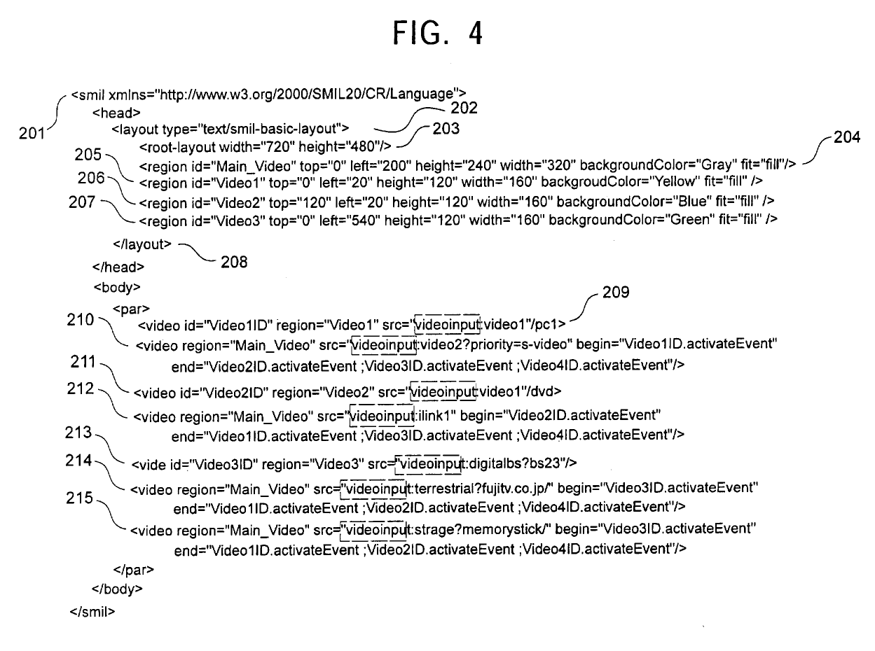

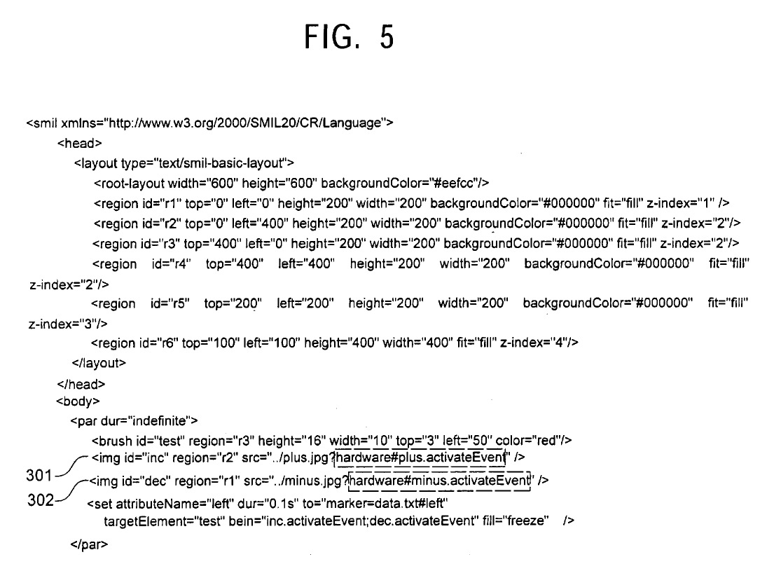

FIG. 1 diagrammatically shows the system of a television set of a first embodiment of the present invention, FIG. 2 is a block diagram of the controller illustrated in FIG. 1, FIG. 3 is a diagram of a software stack, FIG. 4 shows a display information program containing a description of videoinput, and FIG. 5 shows a display information program for adjusting contrast.

Referring to FIG. 1, a television set 1 includes a interface 2 to which an external information source is connected, an A/V SW 3 for separating video information and audio information input from the interface 2 from each other, a video module 4 for processing the video information from the A/V SW 3, an audio module 5 for processing the audio information, and a controller 6 for controlling these components.

The interface 2 includes a network interface 7 connected to the Internet, BS (Broadcasting Satellite) tuner 8 for satellite broadcast signal, terrestrial broadcasting tuner 9 for terrestrial broadcast signal, a couple of video and audio terminals, including VIDEO 1 video input terminal 10, and audio input terminal 11, VIDEO 2 video input terminal 12, and audio input terminal 13, memory card slot 14 for receiving information from a memory card, and i. LINK (DV terminal) 15 for receiving information from a digital video camera, etc.

The video input terminal 10 may receive information from a DVD (Digital Versatile Disk) through a disk recorder.

Furthermore, the video input terminal 10 may receive information from a PC (Personal Computer) or gaming software information.

The video module 4 includes a Y/C signal processor 16 which controls a synchronization process for Y (luminance signal) and C (chrominance signal) based on video information from the A/V SW 3 and control information from the controller 6, and a display 17 which presents the video information under the control of the Y/C signal processor 16.

The audio module 5 includes a sound processor 18 which controls the audio information from the A/V SW 3 which reproduces sound nearly equal to richly expressed live performance, or fine and subtle sound difference from musical instrument to musical instrument, audio amplifier 19 for amplifying the audio signal, and a loudspeaker 20 for converting the audio signal into sound heard by humans.

Referring to FIG. 2, the controller 6 includes a CPU (Central Processing Unit) 21 for performing calculation and controlling the entire system, RAM (Random Access Memory) 22 and ROM (Read Only Memory) 23 which store temporarily the video information, audio information, data and software programs as necessary for smooth control of the television set 1 as an electronic apparatus, data storage 24 and software storage 25 for storing a variety of software programs.

The data storage 24 stores, as screen layout data 26, display information program which is produced beforehand as screen layout, such as the one having an SMIL description under the control of controller 6 based on file system library 29 of a software stack shown in FIG. 3.

The software storage 25 includes a description reader 38, description determiner 39, layout unit 40, interface selector 41, and information control unit 42.

Under the control of the CPU 21, the description reader 38 reads a description of the display information program stored as the screen layout data 26 in the data storage 24, and send the read information to the description determiner 39.

Based on an XML parser 32 and SMIL parser 34 in the software stack shown in FIG. 3 to be discussed later, the description determiner 39 determines whether the read program is a correct XML document. If it is determined that the read program is a correct XML document, the SMIL parser 34 performs a parsing operation. The description determiner 39 further determines whether the read program is an SMIL document. If it is determined that the read program is an SMIL document, the description determiner 39 performs a parsing operation, thereby decomposing the SMIL document into meaningful segments.

Specifically, the description determiner 39 divides the segments into a part that defines a plurality of display areas and lays out the plurality of display areas, and a part which defines an external information source at which information to be displayed in the defined display areas is originated and which allows other information to be attached thereto. The displaying of information from a particular external information source is defined. Using the rule of URI, the external information is laid out on a display screen with layout freedom.

More specifically, the description determiner 39 classifies the segments into head components and body components, and determines in the head component whether a display area is defined and laid out for a layout component, and determines what external information source, at which information to be displayed in the defined display area is originated, is defined in the body component.

A method of the description determiner 39 for determining the information source at which information to be displayed in the display area defined by a video component within the body component is originated is available. For example, the description determiner 39 determines whether “src=” in the read display information program is followed by a scheme called “videoinput” using a software of a URI search engine 37 in the software stack in FIG. 3 to be discussed later. If it is determined that there is no scheme called “videoinput”, the CPU 21 controls the screen layout, handling the received display information program as an ordinary file in the television set 1 or information over the WEB (World Wide Web).

If it is determined that there is a scheme called “videoinput”, display information such as “video1” is transferred to the interface selector 41, for example.

The description determiner 39 checks a part that defines the external information source at which information to be displayed in the display area is originated, and also checks the content of a part to which other information is attached.

For example, the scheme of URI, which defines an external information source at which information is to be displayed is originated, is followed by a part of the external information source. The description determiner 39 then determines whether “?” reserved for the display information program read as a query component of the URI is present. If it is determined “?” is present, the display information following “?” is transferred to the information control unit 42. In this way, the display information following “?” is provided to the information control unit 42 as a control parameter.

The layout unit 40 receives layout information based on the determination of the description determiner 39 which has defined a plurality of display areas of the read program to be laid out. Under the control of the CPU 21, the layout unit 40 lays out the display screen based on a window system 28 of the software stack shown in FIG. 3.

In response to the display information such as “video1” conveyed by the description determiner 39, the interface selector 41 selects a corresponding interface through an OS 27 in the software stack shown in FIG. 3.

The information control unit 42 transfers specific channel information such as of BS broadcasting to the BS tuner 8 and control information for individual apparatus to a corresponding apparatus, in accordance with display information control parameters provided by the description determiner 39.

In response to the display information control parameters from the description determiner 39, the information control unit 42 may prioritize an S-Video input if both CV input and S-Video input are fed to a single video input of the television set 1.

The components of the television set 1 are arranged as in the software stack shown in FIG. 3 which presents a typical structure of basic software of a display screen layout.

Specifically, the OS (Operating System) 2 is positioned at the lowest hierarchical layer. Positioned above the OS 2 are window system 28, file system library 29, and network library 30. Then, CSS (Cascading Style Sheets) 31, XML parser 32 and HTML (Hyper Text Markup Language) parser 33 are positioned. Arranged above the XML parser 32 are SMIL parser 34, BML (Broadcast Markup Language) 35 and WML (Wireless Markup Language) 36. The URI search engine 37 is positioned above the SMIL parser 34.

The OS 27 generally manages the software program positioned thereabove and the hardware positioned therebelow, such as an interface. The window system 28 divides the screen of a graphic display into a plurality of rectangular partitions, thereby presenting a variety of pieces of information on the partitions. Under the control of a software program positioned above the window system 28, the window system 28 controls the layout unit 40, and lays out the video information on the display screen input through an interface using the OS 27.

The file system library 29 is a software program which collects and manages the video information recorded as a file by controlling the data storage 24. The network library 30 is a software program which collects and manages each network. The screen is thus laid out based on collected abundant information with layout freedom.

The CSS 31 is one of cascading style sheet languages for designing a document written in a language such as HTML or XML. Using that software, information is presented in a layout on the display screen like the HTML format.

The XML parser 32 checks and analyzes a produced XML document, the HTML parser 33 checks and analyzes a HTML document obtained from the description determiner 39, and the SMIL parser 34 checks and analyzes a produced SMIL document. The SMIL parser 34 controls the description determiner 39. The SMIL parser 34 decomposes an SMIL document into meaningful segments by parsing the SMIL document. The URI search engine 37 positioned thereabove can search the decomposed segments for description information required for screen layout.

The BML 35 is an XML-based markup language for describing a content of BS digital broadcast signals. The BML 35 lays out contents on the screen and associates one content with another. The BS digital broadcast signals are thus handled as an external information source.

The WML 36 is a WAP language which is a communication protocol for using the Internet on a mobile terminal such as a mobile telephone. The WML 36 allows a mobile terminal to access Internet-based information. In this way, a PDA to be discussed later can lay out information obtained through the Internet on the display screen thereof with more layout freedom.

The languages in use will now be discussed with reference to the information display program.

For example, a display information program written in the SMIL defines display information, for selecting an interface which exchanges signals with an external information source, using a URI scheme which is a definition of database structure.

Specifically, the above-mentioned display information program includes a part which defines a plurality of display areas and lays out the display areas and a part which defines the external information source at which information to be displayed in the defined display areas is originated and allows other information to be attached thereto. In this way, the display information program defines information from a particular external information source. Using the rule of the URI, the information from the external information source is laid out on the display screen with layout freedom.

Referring to an SMIL description shown in FIG. 4, the display information program describes “region id” using a tag name called “region” and attribute “id” in region components 204 through region component 207 to identify a plurality of display areas as “Video1” for example, and uses the SMIL description as a definition of the layout of each display area.

The display areas are defined by the above-mentioned “region id” as shown in video component 209. Using the URI, the display information program identifies the external information source referring to a description in succession to a scheme “videoinput”.

Specifically, a scheme “videoinput” is arranged in an enclosure surrounded with broken line. If the video component 209 includes “videoinput:video1”, the screen of an apparatus input to “video1” is laid out in the case of a television set 1.

Information displayed in a defined display area is defined with “ID”, and may be used in another component.

For example, concerning information displayed in a display area and defined as “Vidoeo1” in region component 205, video component 209 may define “Video1ID”, and a description of “Video1ID” in another video component 210 may use the information defined as “Video1ID”.

The description of URI depends on schemes, and typically begins with a scheme name in use, followed by one colon character “:”, and then a scheme-specific part, the interpretation of which depends on the scheme.

The interpretation of the scheme-specific part following “videoinput” is determined by the scheme “videoinput”. If the scheme is defined as inputting of information through an interface represented by the scheme-specific part following the scheme, this description identifies the external information to be displayed on each display area.

Specifically, an SMIL description following “:” subsequent to “videoinput” may be, in addition to “video1” in the video component 209, “ilink1” as an input i. LINK (DV terminal) in video component 212, “digitalbs” presenting BS shown in video component 213, and “terrestrial” representing terrestrial broadcasting shown in video component 214 as shown in FIG. 4. Referring to video component 209, apparatuses connected to “video1” are specifically identified by placing “pc1” subsequent to “video1″/” in video component 209 and “dvd” subsequent to “video1″/” in video component 211. In this way, an apparatus connected to “video1” is specifically identified. For example, to select “GAME1”, “game1” may be placed in succession to “video1″/”.

Receivers having receiving channels for BS and terrestrial broadcasting must indicate a specific channel and this requirement may be satisfied using the rules of the URI.

Specifically, a method of using query is widely used in URL search HP (Home Page) and HP of BBS (Bulletin Board System). For example, the BBS URL has the following description.

http://bbs.arukikata.co.jp/report/europe/board/index.php?qid=26

“qid=26” subsequent to “?” represents a parameter to be handed over to a CGI (Common Gateway Interface). A server is thus instructed to retrieve No. 26 on a bulletin board of arukikata home page on the BBS system.

By introducing “?”, information is handed over to each apparatus. For example, “?” may be followed by “BS23” in video component 213, and by “fujitv.co.jp” in video component 214 as shown in FIG. 4. In this way, a channel and a broadcasting station UR1, as the display information to select a plurality of external information sources, are indicated. The controller 6 issues a command to acquire information on a Fuji TV channel through a terrestrial broadcasting tuner 9 selected by “videoinput:terrestrial”.

There are two types of video signals input to the video input: S-video inputs with a luminance (Y) signal and a chrominance (C) signal separated from each other, and a CV input which is a composite single input. Each external information source outputs one of the two types. A plurality of inputs and outputs are arranged to receive any of these two types.

Since concurrent inputting of the two types of signals degrades correct video processing, the display information program selects one of the two types.

For example, if both CV input and S-Video inputs are applied to a single video input port, the display information program may prioiritize “S-Video” by writing “videoinput:video2?prioirity=s-video” in video component 210.

In the method of expressing query as described above, the scheme-specific part is followed by “?”, and then by an information part which is a query component of the URI, for example, in accordance with the rule of the URI.

The information part as the query component is interpreted by the scheme-specific part as a resource in the URI rule, and provides some information relating to the description of the scheme-specific part which comes prior to “?” in the URI rule.

Specifically, the above-mentioned “videoinput:video2?priority=s-video” is composed of “videoinput” as a URI scheme, “:”, “video2” as the scheme-specific part, the interpretation of which depends on the scheme, “?”, and “priority=s-video”.

In the above arrangement, “videoinput:video2” specifies that the screen information of an apparatus input to the interface represented by “video2” is processed, and “?priority=s-video” specifies that the S-Video has priority if a plurality of video signals are input.

Using “?”, the animation function of the SMIL is used, for example, to change dynamically the color of a drawing or to move the drawing. Picture and contrast of the display screen and the apparatuses are thus controlled. The description of the SMIL in this case is shown in FIG. 5.

The simple use of “?”, which is reserved in the URI, permits the user of all reserved characters in RFC (Request For Comments): 2396 defining the URI identifying an address over the Internet used in the SMIL description.

The display information program contains, as the screen layout data 26, several screen layout examples and video information laid out on the screen. The display information program may be stored in not only a magnetic disk or a CD-ROM (CD-Read Only Memory), but also another memory in the controller 6 or an external memory. The display information program is used in a versatile fashion, thereby forming a screen layout matching the apparatus of a client.

The operation of the television set 1 thus constructed is now discussed.

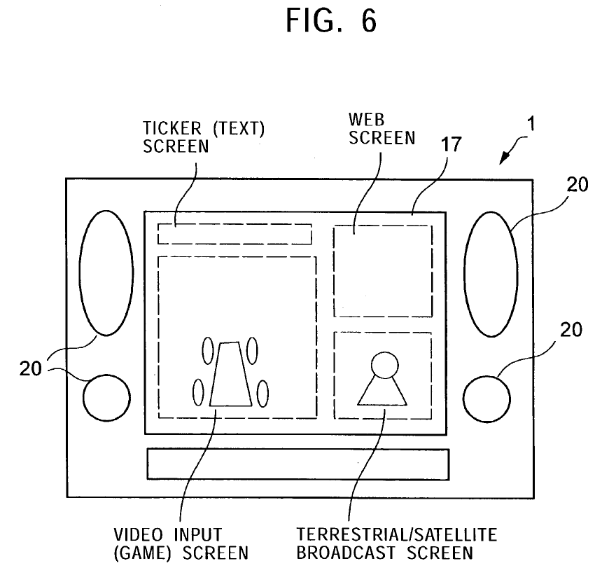

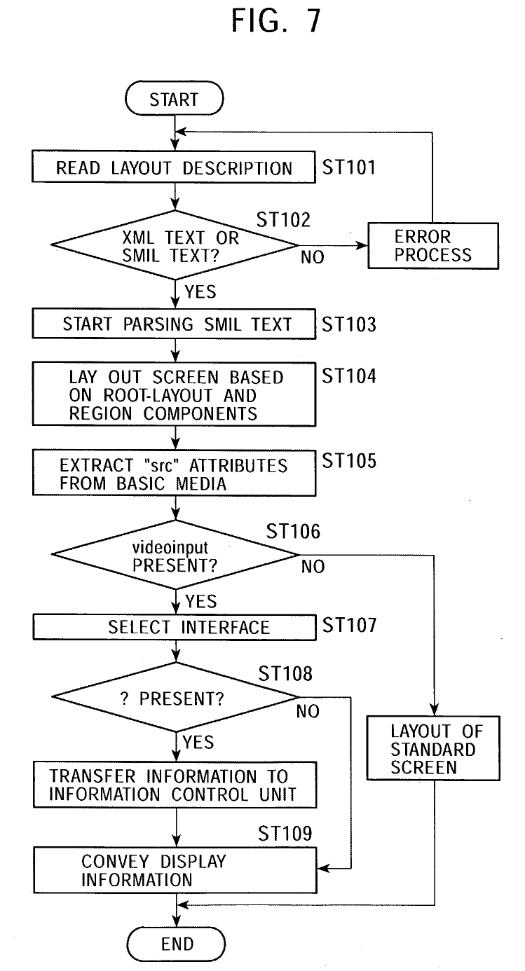

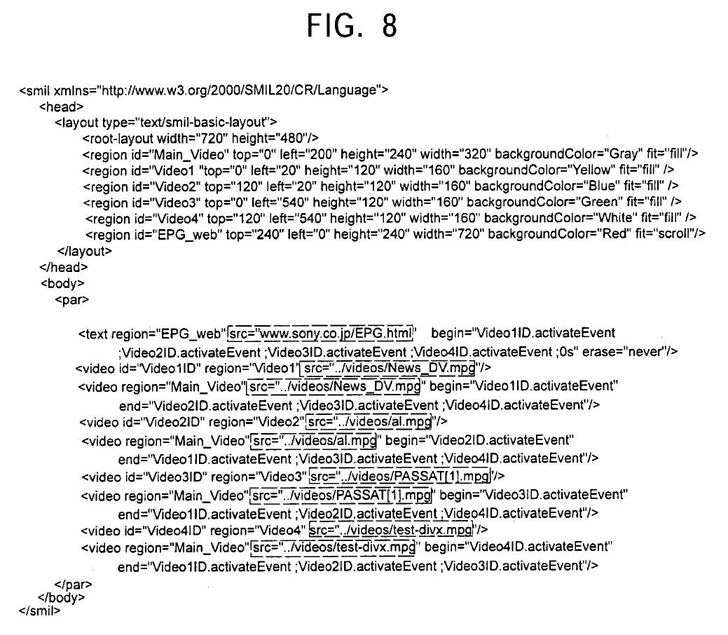

FIG. 6 shows a screen presenting a video input, FIG. 7 is a flow diagram of the first embodiment of the present invention, and FIG. 8 shows a conventional description of the SMIL.

Referring to FIG. 6, text information, Web information, terrestrial broadcast information, and gaming information as a video input are currently presented on the screen of the television set 1.

When the display information program is produced beforehand and stored as the screen layout data 26 in the data storage 24, the description reader 38 in the controller 6 reads required display information from the screen layout data 26 in the data storage 24 as shown in FIG. 7, and starts reading a layout description of the program (ST101).

If there are several display information programs, the CPU 21 causes the description reader 38 to present the programs on the screen of the television set 1 so that a viewer may choose one of programs. For example, the CPU 21 presents screen layouts of the plurality of display information programs juxtaposed in a contracted form on the television screen to the user for choice.

The CPU 21 determines whether or not the description read in the description determiner 39 in the controller 6 is an XML document and determines whether or not the description read in the description determiner 39 in the controller 6 is an SMIL document (step ST102). If it is determined that the read document is neither an XML document nor an SMIL document, an error process is activated.

If is determined that the read document is an SMIL document, the CPU 21 instructs the description determiner 39 to parse the SMIL document, and the description determiner 39 starts decomposing the SMIL document (step ST103).

The description determiner 39 sorts decomposed segments into a component which defines a plurality of display areas and lays out the display areas and a component which defines the external information source at which information to be displayed in the defined display areas is originated and which allows other information to be attached thereto. The description determiner 39 checks the content of each component.

In a method of defining the plurality of display areas and laying out each of the display areas, the description determiner 39 conveys, to the layout unit 40, layout information in “root-layout” and region components from <layout type=” text in component 208 through </layout>in component 208 in the SMIL document illustrated in FIG. 4, and lays out the screen of the television set 1 based on the window system 28 in the software stack shown in FIG. 3 (step ST104).

The display information program with top=0, and left=200 in the region components in component 204 declares that the area of “Main Video” extends from 0 at the top left to 200 rightward. If time component is factored in, the layout is performed in time scale.

The presence of the URI scheme for defining the external information source at which the information to be displayed in the region component defined display area is originated must be determined. The description determiner 39 extracts “src” attributes from Basic Media in the SMIL document (step ST105), and the description determiner 39 determines whether “videoinput” as one of URI schemes is present in corporation with the URI search engine 37 in the software stack in FIG. 3 (step ST106).

Upon determining that “videoinput” is present, the description determiner 39 sends, to the interface selector 41, a parameter which is the display information in succession to the “videoinput”. In response to the parameter, the interface selector 41 selects an interface (step ST107).

If the description determiner 39 determines that no “videoinput” is present, screen layout is performed based on video information present in a file and video information designated by a URL of Web when a description is in a portion surrounded with broken line as shown in FIG. 8.

If it is determined in step ST106 that “videoinput” is present, and if an interface is selected in step ST107, the description determiner 39 examines the content of a part of the display information program which defines the external information source at which information to be displayed is originated, and examines the content of a part to which other information is attached.

For example, subsequent to a URI scheme which is a part to define the external information source at which information to be displayed is originated, a target external information source is displayed. The description determiner 39 determines whether “?”, reserved in the read display information program as a query component of the URI, is present or absent subsequent to the target external information source (step ST108).

If the description determiner 39 determines that no “?” is present, the selected interface transfers display information (step ST109). In this way, a video from an external video device, or a video and still image stored in an external memory, are laid out on the display screen without the need for organizing the video signal in a file. The layout of the display screen thus ends.

If the description determiner 39 determines that “?” is present in the display information program, the display information succeeding “?” is transferred to the information control unit 42. The information control unit 42 transfers the display information succeeding “?” to devices such as interface 2 under the control of the CPU 21 (step ST109). A desired layout on the display screen is completed.

If a description such as “BS 23” appears subsequent to “?” in video component 213 or “fujitiv.jp” appears subsequent to “?” in video component 214 as shown in FIG. 4, the information control unit 42 transfers specific channel information for selecting a channel from a plurality of channels or a BS 3 channel from a broadcasting station to each device.

If a description such as “s-video” appears subsequent to “?” in video component 210, both the CV input and the S-Video input are applied to a single video input of the television set 1. Control information to prioritize the S-Video input is output to each device.

The interface 2 and other devices thus lay out the desired display screen and select a channel.

The display information program for laying out the screen of the television set 1 includes descriptions of a part which defines a plurality of display areas and lays out the display areas and a part which defines an external information source at which information to be displayed in the defined display area is originated, and which allows other information attached thereto. The display information program thus defines the displaying of the information from a particular external information source. Using the rule of the URI, the information from the external information source is laid out on the display screen.

Specifically, since a scheme “videoinput” is arranged as a URI scheme, the display information for selecting the interface that exchanges signals with the external information source is actively designated.

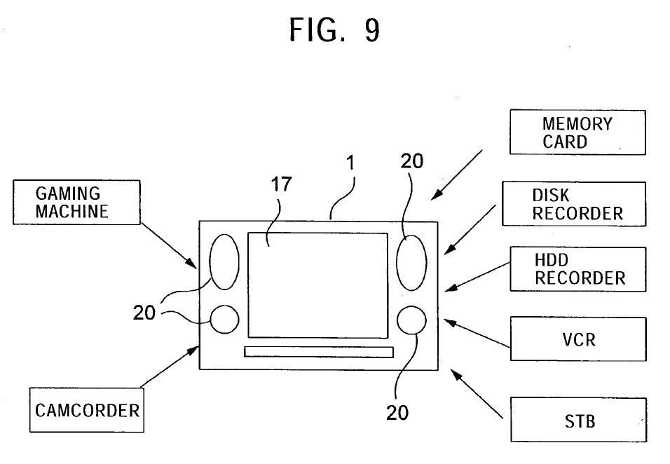

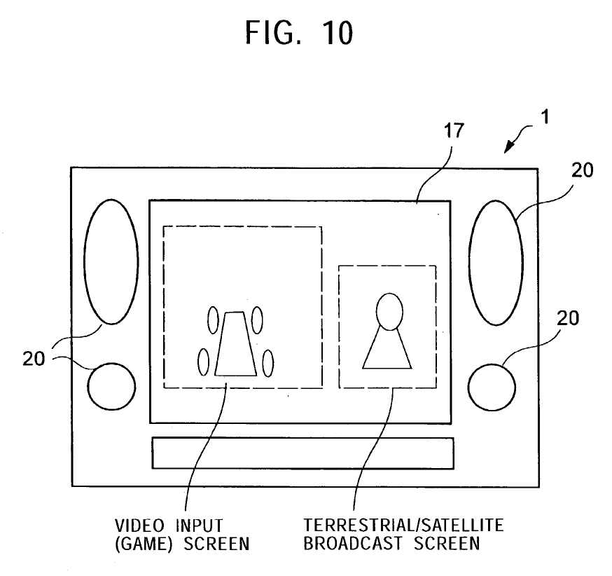

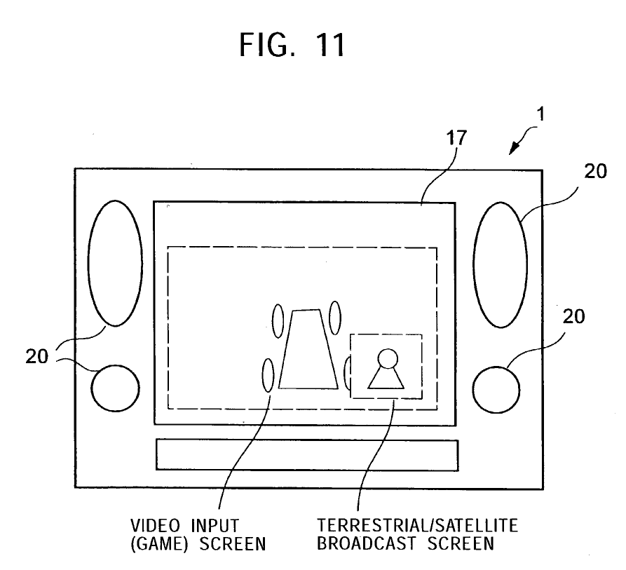

Referring to FIG. 9, a video or still image from an external video device such as a gaming machine, camcorder, non-mobile video cassette recorder, or an external memory device such as memory stick, SD memory card, CompactFlash, smart media, or MMC, is presented on the screen of the television set 1. In the conventional art, the information is merely electrically input in a passive state, and is presented, at best, in a pair of right and left screens (in a P-out-P fashion) or in one screen within another (in a P-in-P fashion) as respectively shown in FIGS. 10 and 11. In accordance with the present invention, information is positively presented in a freely set screen layout without the need for converting the information into a file the electronic apparatus of the display can recognize.

The electronic apparatus of a second embodiment of the present invention will now be discussed. The electronic apparatus is a television set 1 in the second embodiment like in the first embodiment.

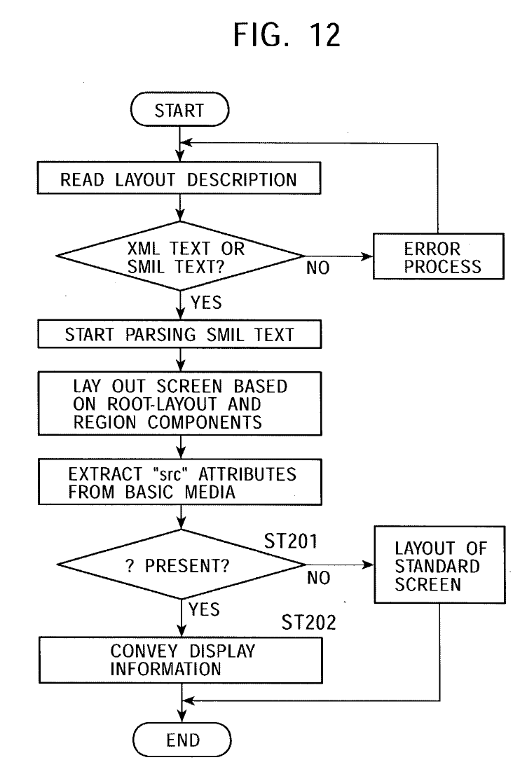

FIG. 12 is a flow diagram of the second embodiment of the present invention.

The construction of the television set 1 of the second embodiment remains unchanged from that of the first embodiment, and the discussion thereof is omitted here.

The operation of the television set 1 in accordance with the second embodiment is discussed below. The description reader 38 in the controller 6 reads a display information program. The reading of the display information program to start the reading of the layout description to the extraction of attributes of “src” from Basic Media, performed by the description reader 38 in the controller 6, remain unchanged from those steps in the first embodiment, and the discussion thereof is omitted here.

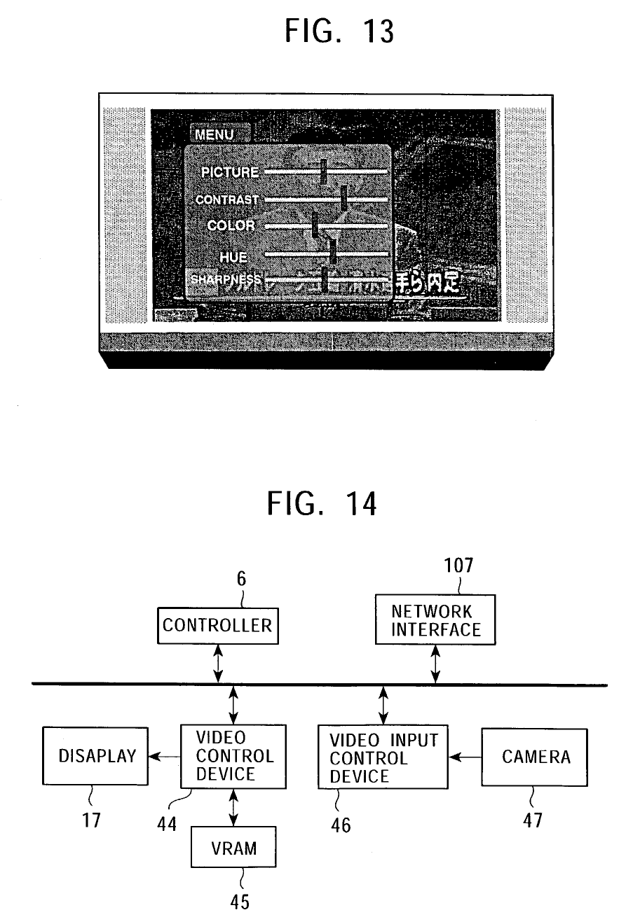

FIG. 13 shows a adjustment screen for contrast, etc., in accordance with the second embodiment of the present invention.

The description determiner 39 divides segments into two major component types, head components and body components, defines a display area for each head component, and defines an imag component out of the body components as information to be displayed in the layout display area, and further checks the content of reserved “?” as a query component of the URI.

As shown in FIG. 12, the description determiner 39 determines whether “?” is present in the attribute of “src” in the display information program read by the description reader 38 as in “plus.jpg?hardware#plus.activateEvent” in component 301 as shown in FIG. 5 (step ST201).

If the description determiner 39 determines that “?” is present, display information subsequent to “?” is transferred to the information control unit 42. Under the control of the CPU 21, the information control unit 42 then transfers the display information subsequent to “?” to each unit (step ST202).

In the above example, the information character string “hardware#plus.activateEvent” subsequent to “plus.jpg” is interpreted in accordance with a resource of the URI “plus.jpg” using the query component of the URI.

Specifically, “plus.jpg” means a button for a plus direction appearing on the screen of the television set 1 as shown in FIG. 13. Operation information to shift that button in a plus direction in response to parameter information “hardware#plus.activateEvent” is transferred to each unit.

The CPU 21 temporarily stores the parameter information “hardware#plus.activateEvent” in the RAM 22, and controls the display 17 as hardware of the television set 1 to adjust contrast of the screen in a plus direction. The control operation of the apparatus then ends.

If the description determiner 39 determines that no “?” is present, layout of the screen is performed in accordance with video information present in the file and video information designated by the URL of Web. The process then ends.

In accordance with the second embodiment, the display information program has descriptions of a part which defines and lays out a plurality of display, and a part which defines information to be displayed in the defined display area and attaches related information to the defined display area. The reserved “?” as a query component of the URI is used in the attachment of information. Information represented by the information character string subsequent to “?” is interpreted by a resource of the URI placed prior to “?”. The hardware appearing on the screen is defined as the resource of the URI, and is processed by the information represented by the information character string.

Specifically, “plus.jpg” is described as a resource of the URI prior to “?” using the reserved “?” in the “src” attribute of the display information program. The information character string “hardware#plus.activateEvent” subsequent to “?” is written as a parameter. The parameter “hardware#plus.activateEvent” interpreted by “plus.jpg” is transferred to each unit under the control of the CPU 21. As a result, on-screen operation shown on the television set 1 controls hardware.

The control of hardware is not limited to the description of “plus.jpg” and “hardware#plus.activateEvent” if the rule of the query component of the URI is used. Other descriptions may control hardware using on-screen operation.

The electronic apparatus of a third embodiment of the present invention is discussed below.

In the third embodiment, a PDA 43 is used as the electronic apparatus.

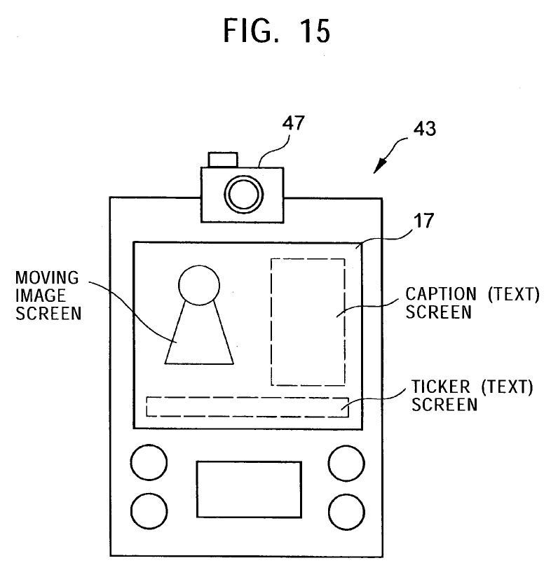

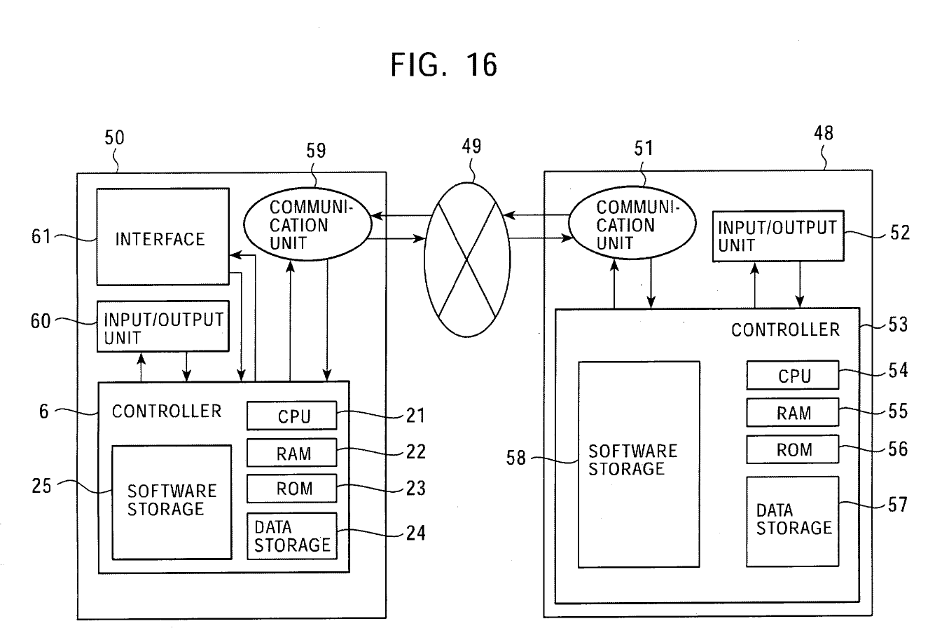

FIG. 14 is a block diagram of the PDA 43, and FIG. 15 is an external view of the PDA 43. As shown, components identical to those described with reference to FIGS. 1 and 2 are designated with the same reference numerals, and the discussion thereof is omitted here.

Referring to FIG. 14, the PDA 43 includes a network interface 7, display 17, controller 6, video control device 44 for controlling video information, VRAM (Video Random Access Memory) 45, video input control device 46 for transferring information of a camera to the controller 6, and camera 47.

The network interface 7 may be connected to any type of networks, regardless of wired or wireless type, including an analog MODEM (MOdulator DEModulator), LAN (Local Area Network) ISDN (Integrated Services Digital Network), ADSL (Asymmetric Digital Subscriber Line), FTTH (Fiber-To-The-Home), Bluetooth, and FOMA (W-CDMA). The display 17 uses an LCD (Liquid-Crystal Display), PDP (Plasma Display Panel), etc. for mobility.

The VRAM (Video RAM) 45 is a memory for presenting a video. Since the PDA 43 is a mobile terminal, the VRAM 45 for temporarily storing video data is important.

The camera 47 is compact and may be detachable type. The picture taken by the camera 47 may be laid out on the screen of the display 17.

The operation of the PDA 43 thus constructed remains unchanged from that of the television set 1 except that video information from the camera 47 is additionally input to the PDA 43 as the electronic apparatus, and thus the discussion thereof is omitted here.

In accordance with the third embodiment, the display information program for laying out the screen of the PDA 43 has descriptions of a part which defines and lays out a plurality of display, and a part which defines information to be displayed in the defined display area and attaches related information to the defined display area. The display information program thus defines the displaying of the information from a particular external information source. Using the rule of the URI, the information from the external information source is laid out on the display screen.

Specifically, since a scheme “videoinput” is arranged as a URI scheme, the display information for selecting the interface that exchange signals with the external information source is actively designated.

For example, if the scheme “videoinput” as a scheme of the URI is arranged and then consecutively followed by “:” and “video1” in the display information program, the video information from the camera 47 connected to the interface designated with “video1” is laid out, as is, on the display screen concurrently with or in succession to another text information as shown in FIG. 15.

A program providing apparatus of a fourth embodiment of the present invention will now be discussed.

The fourth embodiment relates to a display information program providing server which is linked with the Internet as a program providing apparatus. The transmission line of the display information program is not limited to the Internet. The transmission line may be any type, regardless of wired or wireless type, as long as the display information program is transmitted therethrough.

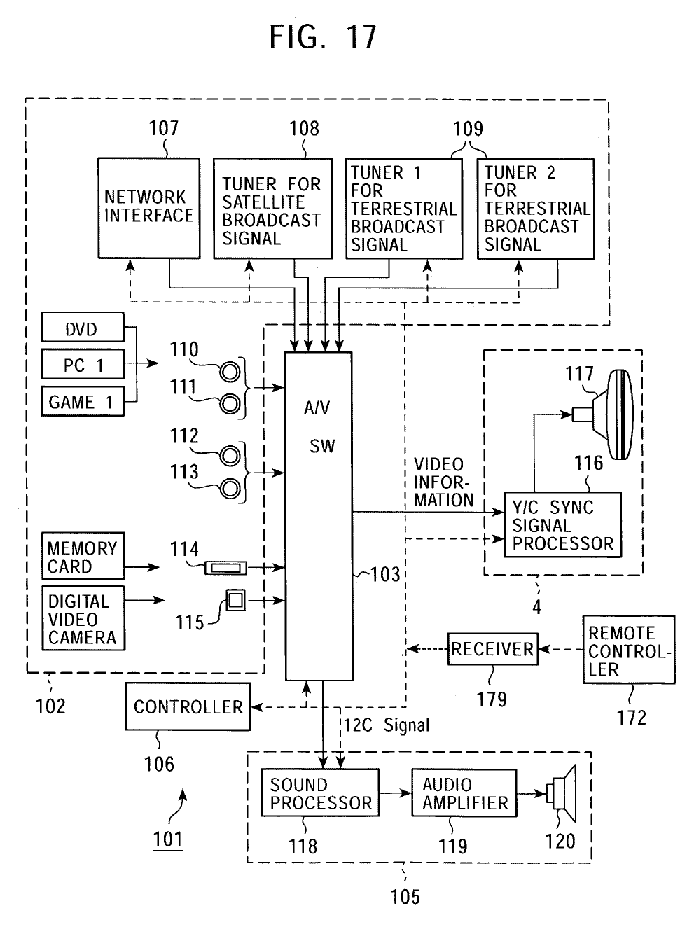

FIG. 16 is a block diagram of the program providing server of the fourth embodiment which provides the display information program to a requesting terminal through the Internet. In connection with the requesting terminal, components identical to those discussed with reference to FIG. 2 are designated with the same reference numerals and the discussion thereof is omitted here.

Referring to FIG. 16, a providing server 48 of the display information program, and a requesting terminal 50 connected thereto through the Internet form a network.

The providing server 48 for providing the display information program has a construction identical to that of a content providing server. The providing server 48 includes a communication unit 51 for communicating with terminals through the Internet 49, input/output unit 52 such as a keyboard, display, and loudspeaker, and controller 53.

The controller 53 includes a CPU 54 for performing processes, RAM 55, ROM 56, data storage 57 for storing a variety of data, and software storage 58 for storing a variety of software programs.

The data storage 57 stores beforehand data concerning a program requester and the display information program relating to the layout of the display screen produced beforehand.

The software storage 58 includes a home page presenter, program requester authenticator, and data transmitter, etc.

The requesting terminal 50, such as a personal computer, includes a communication unit 59 which performs communication over the Internet 49, input/output unit 60 such as a keyboard, display, or loudspeaker, and interface 61 for exchanging information with an external information source. The requesting terminal 50 is not limited to the personal computer, and may be the PDA 43 or a mobile telephone.

The operation of the providing server 48 for providing the display information program is discussed below.

When URL address information of a home page is input from the requesting terminal 50 to the controller 53 of the providing server 48 through the communication unit 59, the home page presenter presents an information home page of the layout of the display screen to the requesting terminal 50 through the communication unit 51 and the Internet 49.

The requester selects an appropriate display information program code, and inputs the display information program code to the controller 53 of the providing server 48 through the communication unit 59 and the Internet 49. The data transmitter in the controller 53 reads the display information program relating to the layout of the display screen from the data storage 57, and then transfers the display information program to the controller 6 of the requesting terminal 50 through the communication unit 51 and the Internet 49. The display information program is then stored as the screen layout data 26 in the data storage 24.

The description reader of the controller 6 reads required display information program from the screen layout data in the data storage 24, and starts the reading of layout description of the program.

The CPU 21 determines whether the description read into the description reader of the controller 6 is an XML document or an SMIL document. If it is determined that the read description is neither an XML document nor an SMIL document, an error process is performed.

If it is determined the read description is an SMIL document, the CPU 21 instructs the description determiner to parse the SMIL document. The description determiner decomposes the SMIL document.

The description determiner divides the decomposed segments into a part which defines and lays out a plurality of display areas, and a part which defines the external information source at which the information to be displayed in the defined display area is originated and to which other information is attached, and then checks the content of each part.

The CPU 21 checks the presence of a URI scheme defining the external information source at which the information to be displayed in the display area defined by the region component described in the display information program written in the SMIL text is originated. To this end, the description determiner extracts the “src” attributes from the basic media in the SMIL text, and determines whether “videoinput”, one of the URI schemes, is present.

If the description determiner determines that “videoinput” is present, the parameter as the display information succeeding to “videoinput” is fed to the interface selector. In response to the parameter, the interface selector selects the interface.

Video and still images from an external video input device or an external storage memory are directly laid out on the display screen without the need for converting the information into a file the electronic apparatus of the display can recognize. This operation has been difficult to perform with the conventional SMIL text.

In the fourth embodiment, the providing server 48 provides the display information program to the requesting terminal 50 through the Internet as the transmission line in response to the request from the requesting terminal 50. Upon receiving the display information program from the providing server 48, the requesting terminal 50 freely lays out video information such as video or game playing software programs input to the electronic apparatus, using “videoinput” as one of the URI schemes in the video components in the display information program.

Discussed next is a television set having a screen layout selector in accordance with a fifth embodiment.

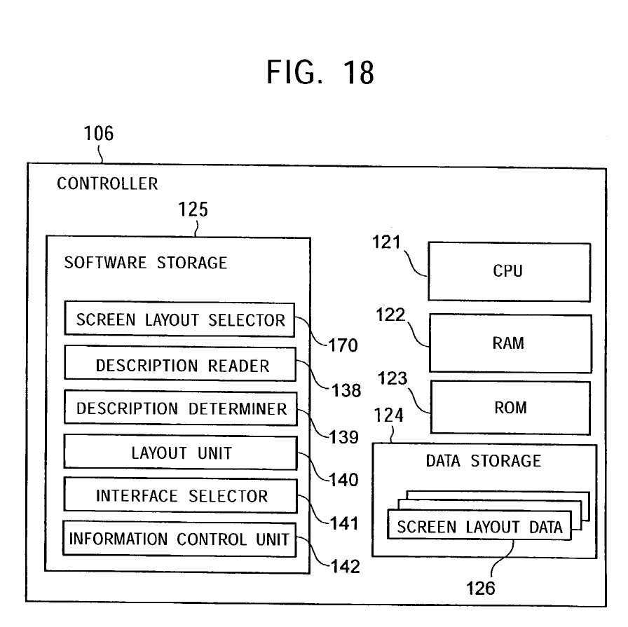

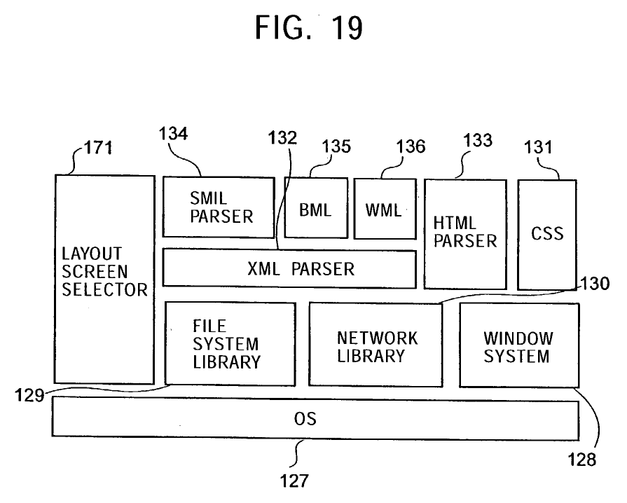

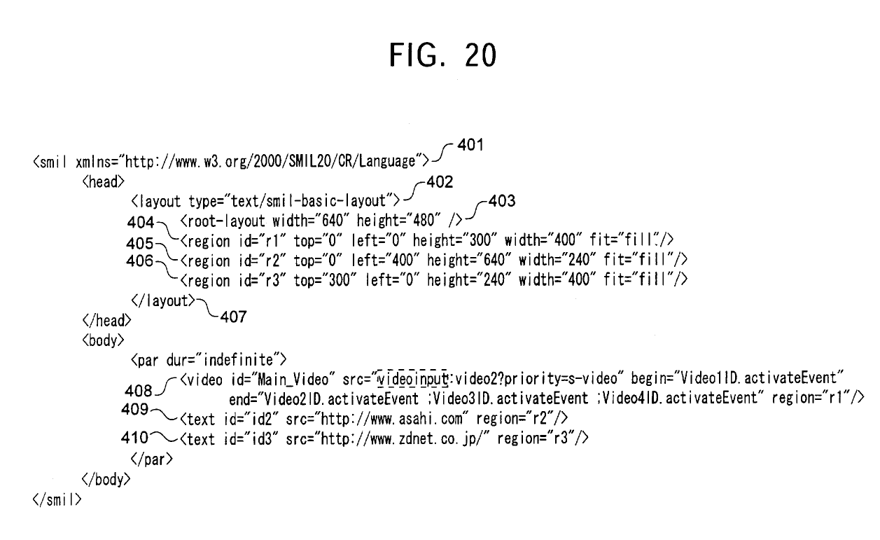

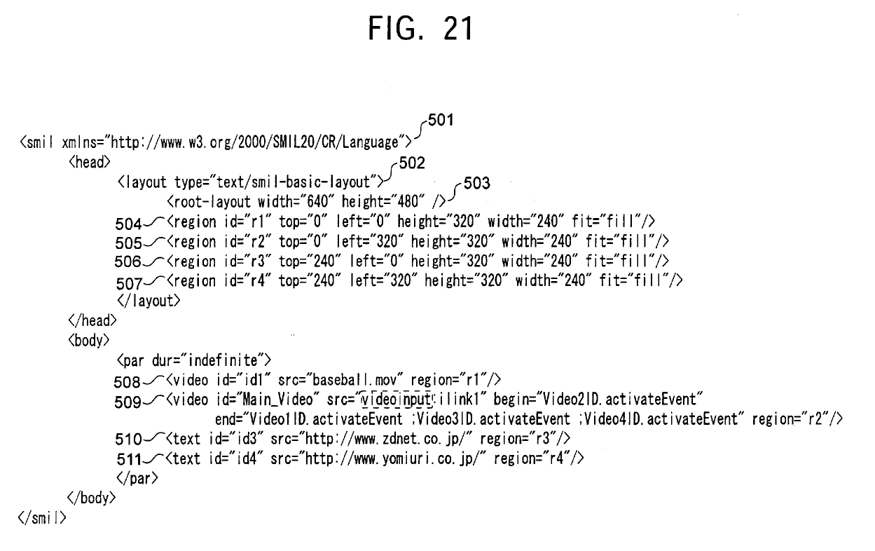

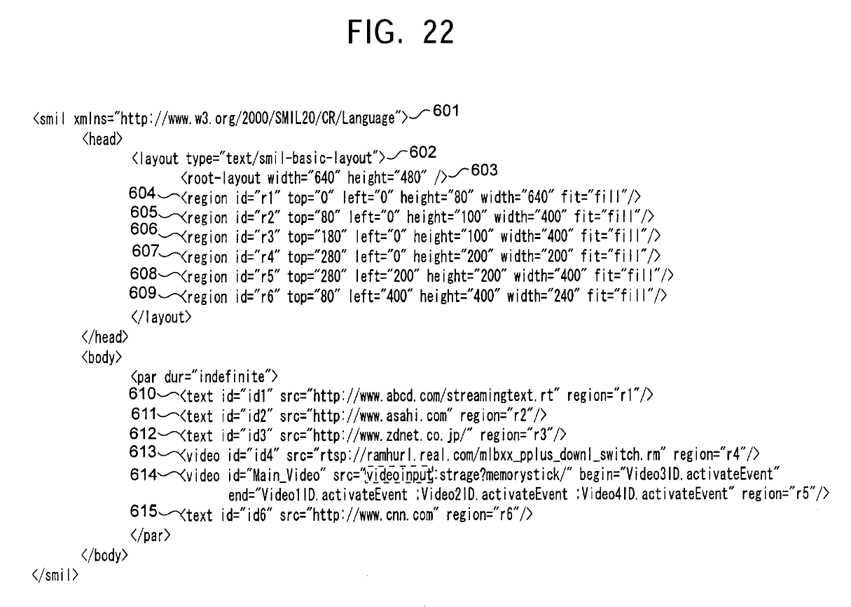

FIG. 17 is a block diagram showing a system of television set in accordance with the fifth embodiment of the present invention, FIG. 18 is a block diagram of the controller of FIG. 17, FIG. 19 is a diagram of a basic software stack of a display screen layout in accordance with the fifth embodiment, FIG. 20 shows a display information program for a screen layout 1, FIG. 21 shows a display information program of a screen layout 2, and FIG. 22 shows a display information program of a screen layout 3.

Referring to FIG. 17, a television set 101 includes a interface 102 to which an external information source is connected, A/V SW 103 which separates audio information from video information input from the interface 102, video module 104 which processes video information from the A/V SW 103, audio module 105 which processes the audio information, receiver 179 which receives a signal from a remote controller 172 for selecting broadcast programs, and transfers the signal to the controller 6, and controller 106.

The interface 102 is provided with a network interface 107 connected to the Internet, satellite broadcasting tuner 108 for selecting satellite broadcast signals, a terrestrial broadcasting tuner 109 for selecting terrestrial broadcast signals, a couple of video and audio terminals, including VIDEO1 video input terminal 110, and audio input terminal 111, VIDEO 2 video input terminal 112, and audio input terminal 113, memory card slot 114 for receiving information from a memory card, and i. LINK (DV terminal) 115 for receiving information from a digital video camera, etc.

The video input terminal 110 may receive information from a DVD (Digital Versatile Disk) through a disk recorder.

Furthermore, the video input terminal 110 may receive information from a PC (Personal Computer) or gaming software information.

The video module 104 includes a Y/C signal processor 116 which controls a synchronization process for Y (luminance signal) and C (chrominance signal) based on video information from the A/V SW 103 and control information from the controller 106, and a display 117 which presents the video information under the control of the Y/C signal processor 16.

The audio module 105 includes a sound processor 118 which controls the audio information from the A/V SW 103 which reproduces sound nearly equal to richly expressed live performance, or fine and subtle sound difference from musical instrument to musical instrument, audio amplifier 119 for amplifying the audio signal, and loudspeaker 120 for converting the audio signal into sound heard by humans.

Referring to FIG. 18, the controller 106 includes a CPU (Central Processing Unit) 121 for performing calculation and controlling the entire system, RAM (Random Access Memory) 122 and ROM (Read Only Memory) 123 which store temporarily the video information, audio information, data and software programs as necessary for smooth control of the television set 101 as an electronic apparatus, data storage 124 and software storage 125 for storing a variety of software programs.

The data storage 124 stores, as screen layout data 126, a plurality of pieces of screen layout pattern information and display information program, which are produced beforehand, such as the one having an SMIL description under the control of controller 106 based on file system library 129 of a software stack shown in FIG. 19.

The software storage 125 includes a screen layout selector 170, description reader 138, description determiner 139, layout unit 140, interface selector 141, and information control unit 142.

The screen layout selector 170 determines whether or not information of a display information program corresponding to an identified screen layout stored in the data storage 124 as the screen layout data 126 is present when screen layout selection information is transmitted from the CPU 121 in response to the operation of numeric keys on a remote controller of the television. If there is no problem with the display information program, the CPU 121 instructs the description reader 138 to read and output the display information program.

Under the control of the CPU 121, the description reader 138 reads the description of the display information program, to be stored as the screen layout data 126 in the data storage 124, in response to description read information from the screen layout selector 170, and sends the read information to the description determiner 139.

The description determiner 139 determines whether or not the read program is a correct XML document based on an XML parser 132 and SMIL parser 134 in the software stack in FIG. 19 as will be discussed later. If it is determined that the read program is a correct XML document, the description determiner 139 further determines whether the read program is an SMIL document. If it is determined that the read program is an SMIL document, the SMIL document is parsed and decomposed into meaningful parts.

The description determiner 139 divides the segments into a part which defines and lays out a plurality of display areas, and a part which defines the external information source at which the information to be displayed in the defined display area is originated and to which other information is attached, and then checks the content of each part. The display information program thus defines the displaying of the information from a particular external information source. Using the rule of the URI, the information from the external information source is laid out on the display screen with layout freedom.

Specifically, the description determiner 139 regards the segments as a head component and a body component, and determines in the head component whether a display area is defined and laid out for a layout component, and determines the external information source at which information to be displayed in the display area defined by the body component is originated.

The description determiner 139 determines the external information source of the information to be displayed using the video component out of the body components. In this method, the description determiner 139 determines whether a scheme name “videoinput” appears subsequent to “src=” in the read display information program. If it is determined that no scheme name “videoinput” is present, the display information program is laid out on the screen as an ordinary file in the television set 101 or information on the WEB (World Wide Web) under the control of the CPU 121.

If it is determined that the scheme name “videoinput” is present, display information such as “video1” is transferred to the interface selector 141.

The description determiner 139 further checks the content of the part of the display information program which defines the external information source at which the information to be displayed is originated and the part to which other information is attached.

For example, the target external information source is appears subsequent to the URI scheme that becomes a part defining the external information source of the information to be displayed. The description determiner 139 determines whether “?”, reserved in the read display information program as a query component of the URI, is present or absent subsequent to the URI scheme. If it is determined “?” is present, display information subsequent to “?” is transferred to the information control unit 142. In this way, the display information subsequent to “?” is fed to the information control unit 142 as a control parameter.

The layout unit 140 receives layout information based on the determination of the description determiner 139 concerning the part which defines the plurality of display areas in the read program to lay out the display areas. Under the control of the CPU 121, the layout unit 140 lays out video information on the display screen based on the window system 128 in the software stack shown in FIG. 19.

The interface selector 141 selects the interface matching the display information such as “video1” transmitted from the description determiner 139, through OS 127 in the software stack shown in FIG. 19.

In response to the display information control parameter provided by the description determiner 139, the information control unit 142 transfers specific channel information of satellite broadcasting to the satellite broadcasting tuner 108, and transfers control information of individual apparatus to corresponding apparatus.

The information control unit 142 may prioritize S-Video in accordance with the display information parameter provided by the description determiner 139 when both CV input and S-Video input are applied to a single video input of the television set 101.

The blocks of the above-referenced television set 101 are arranged in a basic software configuration for the display screen layout as shown in the software stack in FIG. 19.

Specifically, the OS (Operating System) 127 is positioned at the lowest hierarchical layer. Positioned above the OS 127 are a screen layout selector 171, file system library 129, network library 130, and window system 128. The XML parser 132, HTML (Hyper Text Markup Language) parser 133, and CSS (Cascading Style Sheets) 133 are positioned above the file system library 129, network library 130, and window system 128. Arranged above the XML parser 132 are SMIL parser 134, BML (Broadcast Markup Language) 135 and WML (Wireless Markup Language) 136.

The OS 127 generally manages the software program positioned thereabove and the hardware positioned therebelow, such as an interface.

The screen layout selector controller 171 selects a particular screen layout pattern from several screen layout patterns, and identifies the corresponding display information program based on the selected pattern. The screen layout selector controller 171 controls the screen layout selector 170, thereby causing the description reader 138 to read the display information program stored as the screen layout data 126 in the data storage 124.

The window system 128 divides the screen of a graphic display into a plurality of rectangular partitions, thereby presenting a variety of pieces of information on the partitions. Under the control of a software program positioned above the window system 128, the window system 128 controls the layout unit 140, and lays out the video information on the display screen input through an interface using the OS 127.

The file system library 129 is a software program which collects and manages the video information recorded as a file by controlling the data storage 124. The network library 130 is a software program which collects and manages each network. The screen is thus laid out based on collected abundant information with layout freedom.

The CSS 131 is one of cascading style sheet languages for designing a document written in a language such as HTML or XML. Using that software, information is presented in a layout on the display screen like the HTML format.

The XML parser 132 checks and analyzes a produced XML document, the HTML parser 133 checks and analyzes a HTML document, and the SMIL parser 134 checks and analyzes an SMIL document obtained through the network library 130. The SMIL parser 134 controls the description determiner 139. The SMIL parser 134 decomposes an SMIL document into meaningful segments by parsing the SMIL document.

The BML 135 is an XML-based markup language for describing a content of BS digital broadcast signals. The BML 135 lays out contents on the screen and associates one content with another. The BS digital broadcast signals are thus handled as an external information source.

The WML 136 is a WAP language which is a communication protocol for using the Internet on a mobile terminal such as a mobile telephone. The WML 136 allows a mobile terminal to access Internet based information. In this way, a PDA to be discussed later can freely lay out information obtained through the Internet on the display screen thereof.

The languages in use will now be discussed with reference to the display information program.

For example, a display information program written in the SMIL defines display information, for selecting an interface which exchanges signals with an external information source, using a URI scheme which is a definition of database structure.

Specifically, the above-mentioned display information program includes a part which defines a plurality of display areas and lays out the display areas and a part which defines the external information source at which information to be displayed in the defined display areas is originated and allows other information to be attached thereto. In this way, the display information program defines information from a particular external information source. Using the rule of the URI, the information from the external information source is laid out on the display screen with layout freedom.

Referring to an SMIL description shown in FIG. 20, the display information program describes “region id” using a tag name called “region” and attribute “id” in region component 404 through region component 406 to identify a plurality of display areas as “r1” for example, and uses the SMIL description as a definition of the layout of each display area.

The display areas are defined by the above-mentioned “region id” as shown in video component 408. Using the URI, the display information program identifies the external information source referring to a description following a scheme “videoinput”.

Specifically, a scheme “videoinput” is arranged in an enclosure surrounded with broken line. If the video component 408 includes “videoinput:video2”, the screen of an apparatus input to “video2” is laid out in the case of a television set 101.

The description of URI depends on schemes, and typically begins with the name of a scheme in use, followed by one colon character “:”, and then a scheme-specific part, the interpretation of which depends on scheme.

The interpretation of the scheme-specific part following “videoinput” is determined by the scheme “videoinput”. If the scheme is defined as inputting of information through an interface represented by the scheme-specific part following the scheme, this description identifies the external information to be displayed on each display area.

Specifically, an SMIL description following “:” subsequent to “videoinput” may be, in addition to “video2” in the video component 408 shown in FIG. 20, “ilink1” as an input i.LINK (DV terminal) in video component 509 shown in FIG. 21, and “strage” representing a memory card slot in video component 614 shown in FIG. 22.

A receiver having receiving channels for BS and terrestrial broadcasting must indicate a specific channel and this requirement may be satisfied using the rules of the URI.

Specifically, a method of using query is widely used in URL search HP (Home Page) and HP of BBS (Bulletin Board System). For example, the BBS URL has the following description.

http://bbs.arukikata.co.jp/report/europe/board/index.php?qid=26

“qid=26” subsequent to “?” represents a parameter to be handed over to a CGI (Common Gateway Interface). A server is thus instructed to retrieve No. 26 on a bulletin board of an arukikata home page on the BBS system.

By introducing “?”, information is handed over to the apparatus. For example, “?” may be followed by “memorystick” in video component 614 as shown in FIG. 22. The display information to select a plurality of external information source is thus the memory card. In this example, an instruction to obtain information of memorystick is transferred to a memory card slot 114 selected in accordance with “videoinput:strage” by the controller 106.

There are two types of video signals input to the video input: S-video inputs with a luminance (Y) signal and a chrominance (C) signal separated from each other, and a CV input which is a composite single input. Each external information source outputs one of the two types. A plurality of inputs and outputs are arranged to receive any of the two types.

Since concurrent inputting of the two types of signals degrades correct video processing, the display information program selects one of the two types.

For example, if both CV input and S-Video input are applied to a single video input port, the display information program may prioiritize “S-Video” by writing “videoinput:video2?prioirity=s-video” in video component 408 shown in FIG. 20.

In the method of expressing query as described above, the scheme-specific part is followed by “?”, and then by an information part which is a query component of the URI, for example, in accordance with the rule of the URI.

The information part as the query component is interpreted by the scheme-specific part as a resource in the URI rule, and provides some information relating to the description of the scheme-specific part which comes prior to “?” in the URI rule.

Specifically, the above-mentioned “videoinput:video2?priority=s-video” is composed of “videoinput” as a URI scheme, “:”, “video2” as the scheme-specific part, the interpretation of which depends on the scheme, “?”, and “priority=s-video”.

In the above arrangement, “videoinput:video2” specifies that the screen information of an apparatus input to the interface represented by “video2” is processed, and “?priority=s-video” specifies that the S-Video has priority if a plurality of video signals are input.

Using “?”, the animation function of the SMIL is used, for example, to change dynamically the color of a drawing or to move the drawing. Picture and contrast of the display screen and the apparatuses are thus controlled.

The use of “?”, which is reserved in the URI, permits the use of all reserved characters in RFC (Request For Comments): 2396 defining the URI identifying an address over the Internet used in the SMIL description.

The display information program stores, as the screen layout data 126, several screen layout examples and video information laid out on the screen. The display information program may be stored in not only a magnetic disk or a CD-ROM (CD-Read Only Memory), but also another memory in the controller 106 or an external memory. The display information program is used in a versatile fashion, thereby forming a screen layout matching the apparatus of a client.

The operation of the television set 101 thus constructed is now discussed.

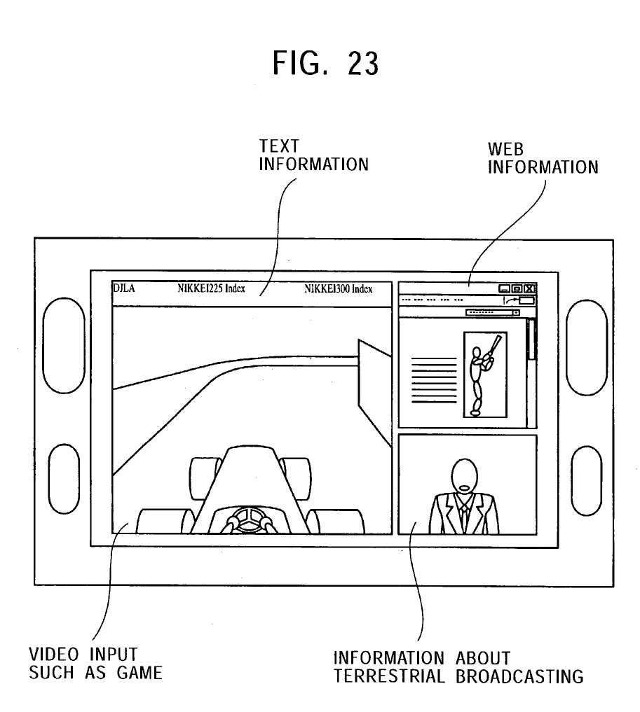

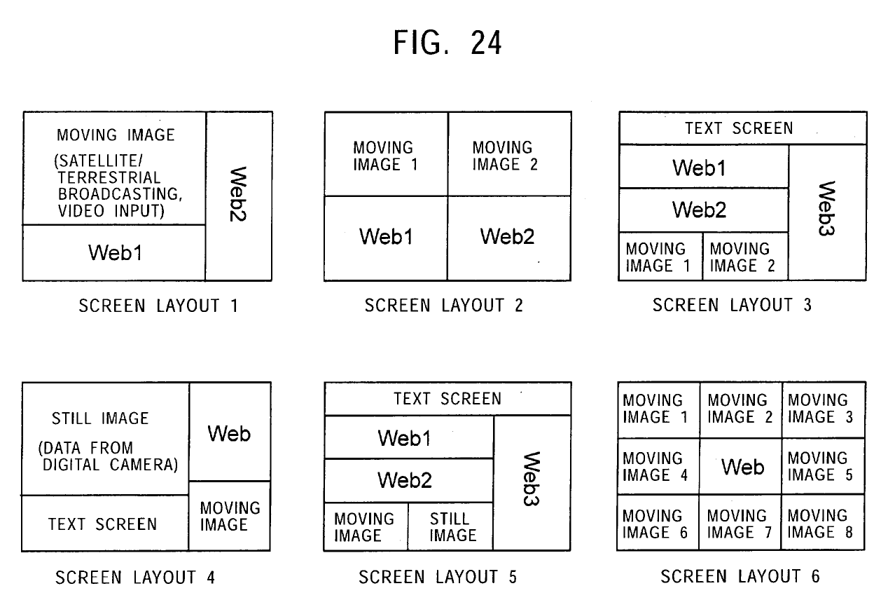

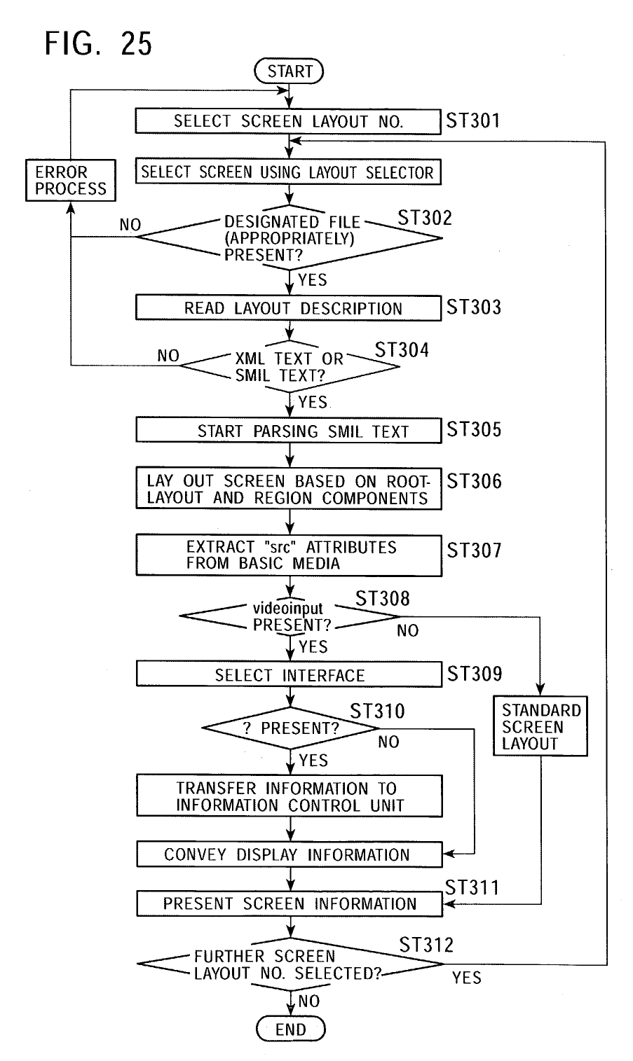

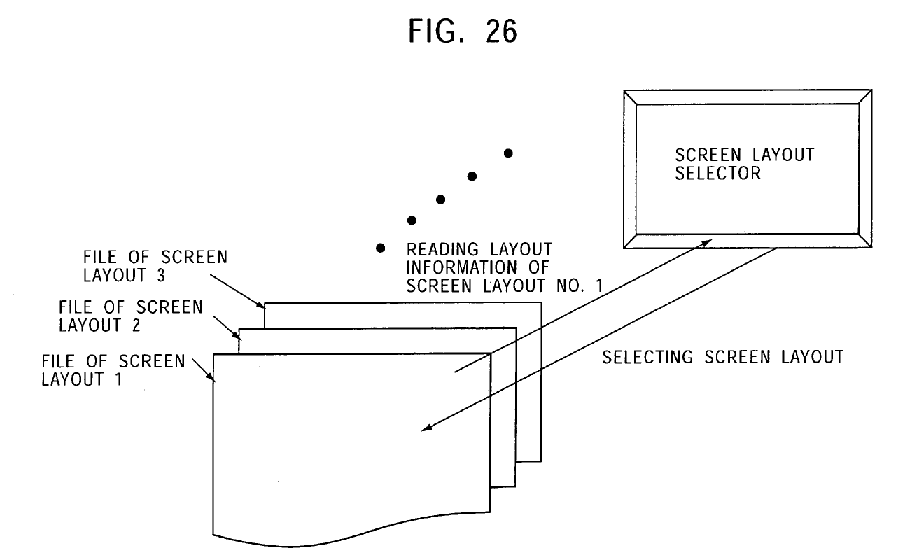

FIG. 23 shows a screen presenting a video input, FIG. 24 shows screen layouts 1 through 6, FIG. 25 is a basic flow diagram of the television set 101, and FIG. 26 shows the relationship between a screen layout and a screen layout selector.

Referring to FIG. 23, the television set 101 presents, on the screen thereof, text information, Web information, terrestrial broadcast information, and game playing information through the video input.

Display information programs describing layouts of a variety of contents from screen layout 1 through screen layout 6 as shown in FIG. 24 are produced. Numbers, which can be input using the numeric keys on the remote controller of the television set 101, are respectively assigned to the screen layouts. The display information program is stored in the data storage 124 as the screen layout data 126. The user switches the screen from one layout to another to select a desired screen layout in which a plurality of desired contents are presented, by operating the remote controller 172 of the television set 101.

Specifically, the display information program files corresponding to screen layout 1 through screen layout 6 are stored in the data storage 124 as shown in FIGS. 24, 25, and 26. For example, the SMIL document screen layout 1 file shown in FIG. 20 representing screen layout 1, the SMIL document screen layout 2 file shown in FIG. 21 representing screen layout 2, and the SMIL document screen layout 3 file shown in FIG. 22 representing screen layout 3 are stored in the data storage 124 together with the respective numbers thereof for identification. The user operates the remote controller 172 of the television set 101 (step ST301), and numeric information for selecting the screen layout is input to the screen layout selector 170, controlled by the CPU 121, through the receiver 179. In step ST302, the screen layout selector 170 selects a corresponding screen layout from the screen layout data 126, and determines whether a corresponding file is present in the screen layout data 126, and further determines whether the information of the file is the file the description reader 138 can read in a next step. If it is determined that no corresponding file is present, an error process resumes.

If it is determined that a corresponding appropriate file is present, the description reader 138 calls the predetermined display information program from the screen layout data 126 in the data storage 124 based on the information from the screen layout selector 170 and starts reading the layout description of the program as illustrated in FIG. 25 (step ST303).

The description determiner 139 determines whether or not the read description is an XML document and whether or not the read description is an SMIL document (step ST304). If the description determiner 139 determines that the read description is neither an XML document nor an SMIL document, an error process resumes.

If it is determined that the read description is an SMIL document, the CPU 121 instructs the description determiner 139 to start parsing the SMIL document. The description determiner 139 thus starts decomposing the SMIL document (ST305).

The description determiner 139 divides the decomposed segments into a part which defines and lays out a plurality of display areas, and a part which defines the external information source at which the information to be displayed in the defined display area is originated and to which other information is attached, and checks the content the parts.

For example, in a method of defining and laying out the plurality of display areas, the description determiner 139 transfers, to the layout unit 140, the layout information of root-layout and region components from <layout type=“text/smil-basic-layout”>in component 402 through </layout>in component 407 in the SMIL document shown in FIG. 20. The layout unit 140 lays out the video information on the screen of the television set 101 in accordance with the window system 128 of the software stack shown in FIG. 19 (step ST306).

The display information program with top=0, and left=200 in the region components in component 404 declares that the area of “r1” extends from 0 at the top left to 200 rightward. If time component is factored in, the layout is performed in time scale as well.

The description determiner 139 determines the presence of the URI scheme for defining the external information source at which the information to be displayed in the region component defined display area is originated. For example, the description determiner 139 extracts “src” attributes from Basic Media in the SMIL document (step ST307), and determines whether “videoinput” as one of URI schemes is present (step ST308).

Upon determining that “videoinput” is present, the description determiner 139 sends, to the interface selector 141, a parameter which is the display information subsequent to the “vidoeinput”. In response to the parameter, the interface selector 141 selects an interface (step ST309).

If the description determiner 139 determines that no “videoinput” is present, screen layout is performed based on video information present in a file and video information designated by a URL of Web when a description in the video component 409 shown in FIG. 20 is present. The algorithm then proceeds to step ST311 as shown in FIG. 25.

If it is determined in step ST308 that “videoinput” is present, and if an interface is selected in step ST309, the description determiner 139 examines the content of a part of the display information program which defines the external information source at which information to be displayed is originated, and examines the content of a part to which other information is attached.

For example, subsequent to a URI scheme which is a part to define the external information source at which information to be displayed is originated, a target external information source appears. The description determiner 139 determines whether “?”, reserved in the read display information program as a query component of the URI, is present or absent subsequent to the target external information source (step ST310).

If the description determiner 139 determines that no “?” is present, the selected interface receives the display information and then transmits screen information such as video information and text information. The screen information is presented in accordance with the screen layout (step ST311). In this way, a video from an external video device, or a video and still image stored in an external memory, are laid out on the display screen without the need for organizing the video signal in a file. Such an operation has been difficult to perform with the conventional SMIL document.

Subsequent to the displaying of the display information, the CPU 121 determines whether information of a number selected in response to the operation of the remote controller 172 is input to the screen layout selector 170 under the control of the CPU 121 (step ST312). If it is determined that the information is input to the screen layout selector 170, the algorithm returns to a state subsequent to step ST301 as shown in FIG. 25; otherwise, the display information such as video and still image identified by the screen layout is continuously presented. The selection of the screen layout thus ends.

If the description determiner 139 determines that “?” is present in the display information program, the display information succeeding “?” is transferred to the information control unit 142. The information control unit 142 transfers the display information succeeding “?” to devices such as interface 102 under the control of the CPU 121. Based on the display information, screen information such as video and text is fed to units such as the interface 102. The video information is presented in accordance with the screen layout on the display 117 under the control of the CPU 121 (step ST311).

If “?” is followed by a description “priority=s-video” as shown in video component 408 in FIG. 20, control information to prioritize S-Video when both the CV input and the S-Video input are applied to a single video input of the television set 101, is transferred to each unit.

As in the same way as when the answer to step ST310 is not affirmative, the operation in step ST310 and subsequent steps are performed to determine whether the screen layout selector 170 has selected a screen layout number (step ST312).

In this way, the interface 102 and other units transfer the screen information including the layout of a desired display screen and contents, and screen layout display is freely presented regardless of the type of external information sources.

The display information program for laying out the screen of the television set 101 includes descriptions of a part which defines a plurality of display areas and lays out the display areas and a part which defines an external information source at which information to be displayed in the defined display area is originated, and which allows other information attached thereto. The display information program thus defines the displaying of the information from a particular external information source. Using the rule of the URI, the information from the external information source is laid out on the display screen.

Specifically, since a scheme “videoinput” is arranged as a URI scheme, the display information for selecting the interface that exchange signals with the external information source is actively designated.

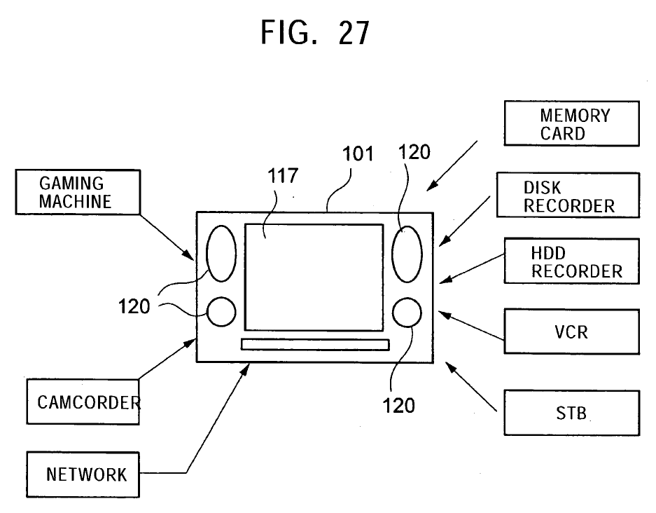

Referring to FIG. 27, the television set 101 receives and lays out a video or still image from an external video device such as a gaming machine, camcorder, non-mobile video cassette recorder, or an external memory device such as memory stick, SD memory card, CompactFlash, smart media, or MMC, from a network such as FTTH (Fiber-To-The-Home), ADSL (Asymmetric Digital Subscriber Line), or ISDN (Integrated Services Digital Network). In the conventional art, the information is merely electrically input in a passive state, and is presented, at best, in a pair of right and left screens (in a P-out-P fashion) or in one screen within another (in a P-in-P fashion) as respectively shown in FIGS. 10 and 11. In accordance with the present invention, information is presented in a freely set screen layout without the need for converting the information into a file the electronic apparatus of the display can recognize.

Even if a video or still image is present in a file or is designated by a URL of WEB, layouts and synchronized replaying of videos from a plurality of media are replayed in accordance with a scenario described in an SMIL format file or XML format file. In this method, content producers typically allow users to view layouts from a plurality of media in a single combination. In principle, the user cannot select a layout. The user simply views the content prepared by a content provider. The electronic apparatuses other than PCs are not expected to work with the user interface operated, and the PC must be operated using a mouse and keyboard, and is thus not necessarily easy to all users. A plurality of display information programs describing a variety of contents and layouts are stored in the data storage with numbers, input through the numeric keys on a remote controller of the electronic apparatus, respectively assigned to the programs. The user switches the screen layouts by controlling the remote controller. The screen layouts are switched one from another freely and easily.

Specifically, the screen layout selector arranged in the controller selectively calls the plurality of display information programs stored as the screen layout data in the data storage again and again, and causes the description reader to read the display information programs. Regardless of the type of external information, the display screen having contents laid out thereon to the user's preference is easily and freely selected.

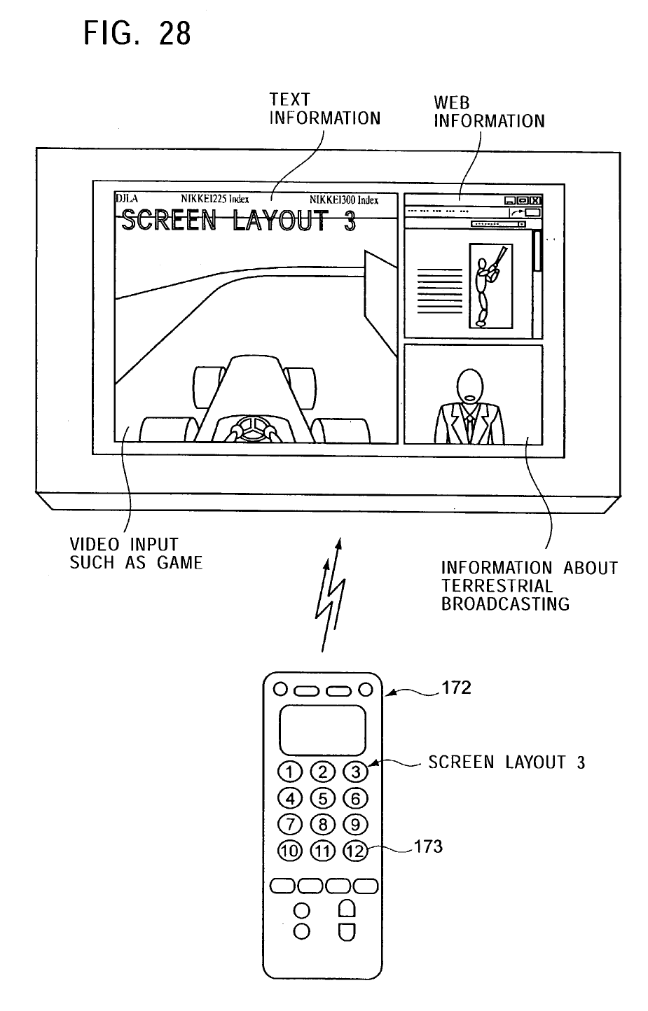

For example, the television set 101 presents video information such as contents freely laid out in accordance with screen layout displays recorded in response to a numeric key 173 and a combination of numeric keys 173 of the remote controller 172 as shown in FIG. 28. By successively changing the numeric keys 173 of the remote controller 172, the screen layouts are displayed and the screen having the video information such as desired contents is easily selected.

Media available for layout process include video medium such as video input, BS (Broadcasting Satellite)/CS (Communication Satellite), or terrestrial broadcasting stations, text medium containing mainly text information, such as Web and plane text, streaming text media such as ticker, and image media which is still image obtained from a digital camera or Web.

A PDA 143 having a screen layout selector in accordance with a sixth embodiment of the present invention will now be discussed.

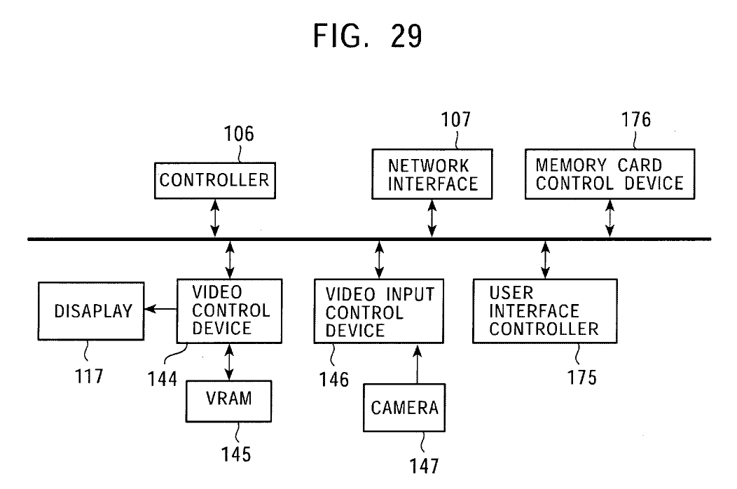

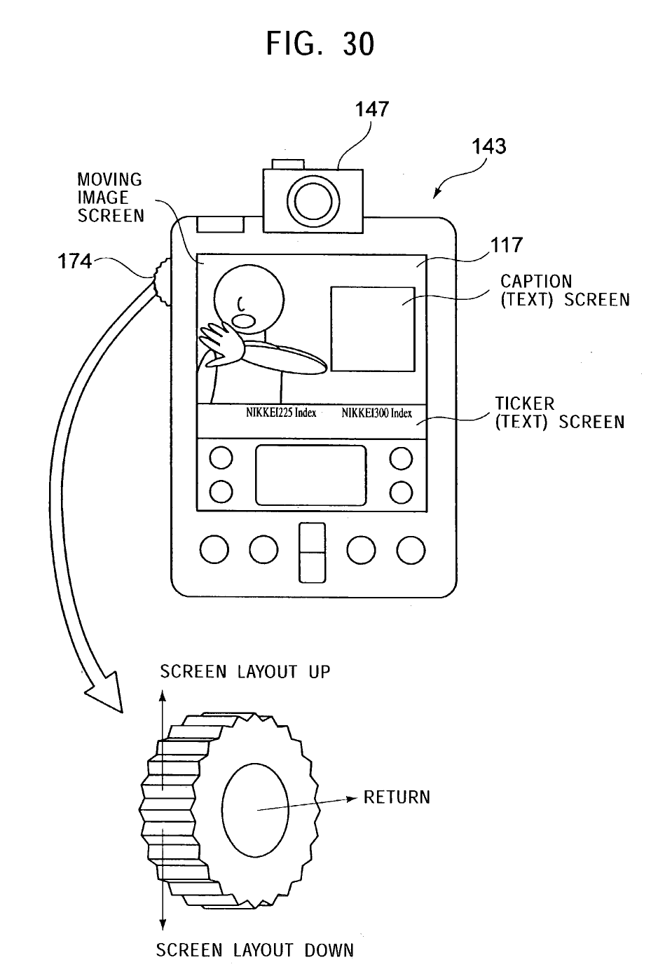

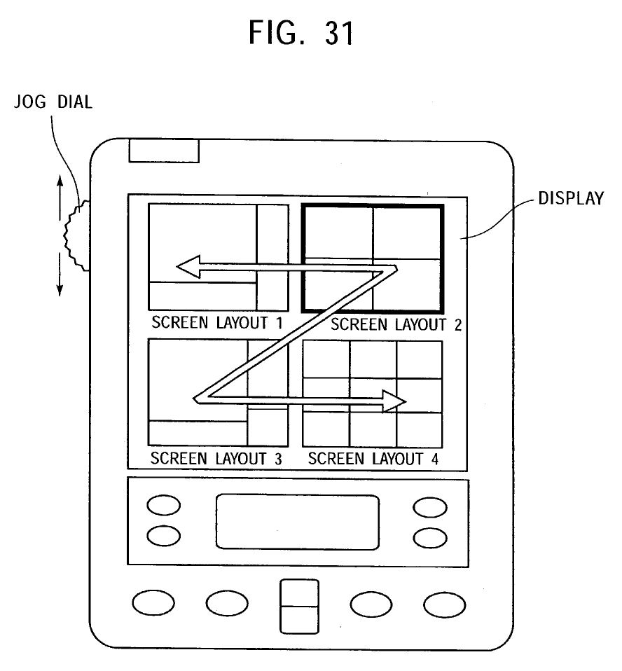

FIG. 29 is a block diagram of the PDA 143 in accordance with the sixth embodiment of the present invention, FIG. 30 is an external view of the PDA 143 in accordance with the sixth embodiment, and FIG. 31 shows the window outline of screen layouts. Components identical to those discussed with reference to FIGS. 17, 18 and 26 are designated with the same reference numerals and the discussion thereof is omitted here.

Referring to FIG. 29, the PDA 143 includes a controller 106, network interface 107, display 117, video control device 144 for controlling video information, VRAM (Video Random Access Memory) 145, video input control device 146 for transferring information of a camera to the controller 6, camera 47, user interface controller 175 for controlling the screen layout information input by the user, and memory card control device 176 for controlling information from a memory card.

The network interface 107 may be connected to any type of networks, regardless of wired or wireless type, including an analog MODEM (MOdulator DEModulator), LAN (Local Area Network), ISDN (Integrated Services Digital Network), ADSL (Asymmetric Digital Subscriber Line), FTTH (Fiber-To-The-Home), Bluetooth, FOMA (W-CDMA). The display 117 uses an LCD (Liquid-Crystal Display), PDP (Plasma Display Panel), etc. for mobility.

The VRAM 145 is a memory for presenting a video. Since the PDA 143 is a mobile terminal, the VRAM 145 for temporarily storing video data is important.

The camera 147 is compact and may be detachable type. The picture taken by the camera 147 may be laid out on the screen of the display 117.

The user interface controlled by the user interface controller 175 receives and transfers the screen layout selection information, and may be a jog dial 174, a push button, keyboard or a remote controller.

The operation of the PDA 143 thus constructed is discussed below.

When the jog dial 174 arranged on the sidewall of the PDA 143 is operated, the PDA 143 successively switches the screen from one screen layout to another out of a plurality of preferred contents.

Display information program files of screen layout 1 through screen layout 6 are stored in the data storage 124 as the screen layout data 126 together with respective numbers identifying the respective files as shown in FIG. 26. Numeric information selected by operating the jog dial 174 of the PDA 143 is input to the screen layout selector 170 under the control of the CPU 121. The screen layout selector 170 selects the screen layout file from the screen layout data 126, determines whether the corresponding file is present, and determines whether the information of the corresponding file is the one which can be read by the description reader 138. If it is determined that no corresponding file is present, an error process resumes.

In response to the information from the screen layout selector 170, the description reader 138 calls the predetermined display information program from the screen layout data 126 in the data storage 124, and starts reading the layout description of the program.

The description determiner 139 determines whether the read description is an XML document or an SMIL document. If it is determined that the read description is neither an XML document nor an SMIL document, an error process is performed.

If it is determined the read description is an SMIL document, the CPU 121 instructs the description determiner 139 to parse the SMIL document. The description determiner 139 starts decomposing the SMIL document.

The description determiner 139 divides the segments into a part which defines and lays out a plurality of display areas, and a part which defines the external information source at which the information to be displayed in the defined display area is originated and to which other information is attached, and then checks the content of each part.

The CPU 121 checks the presence of a URI scheme defining the external information source at which the information to be displayed in the display area defined by the region component described in the display information program written in the SMIL text is originated. To this end, the description determiner 139 extracts the “src” attributes from the basic media in the SMIL text, and determines whether “videoinput”, one of the URI schemes, is present.

If the description determiner 139 determines that “videoinput” is present, the parameter as the display information succeeding to “videoinput” is fed to the interface selector 141. In response to the parameter, the interface selector 141 selects the interface.

Display information is input to the selected interface, and the interface transfers the screen information such as video or text information, causing the screen information to be presented in the screen layout. Video and still images from an external video input device or an external storage memory are directly laid out on the display screen without the need for converting the information into a file. This operation has been difficult to perform with the conventional SMIL text.

Subsequent to the displaying of the display information, the CPU 121 determines whether numeric information input in response to the operation of the jog dial 174 is input to the screen layout selector 170. If it is determined that the numeric information is input to the screen layout selector 170, the algorithm returns to a state subsequent to the input of the number operation in response to the operation of the jog dial 174 of the PDA 143. If it is determined that the numeric information is not input to the screen layout selector 170, the display information such as video and still image identified by the screen layout is continuously presented. The selection of the screen layout thus ends.

Each unit such as the network interface 107 receives and transmits the screen information such as desired layouts of the display screen and contents, thereby presenting freely screen layouts regardless of the type of external information source.

The PDA, typically having a small throughput, has difficulty presenting video in a layout as shown in FIG. 30. Referring to FIG. 31, the screen layouts 1 through 4 having the outline only are selectively and successively presented using the jog dial, for example. When a desired layout outline is presented, that layout is selected by pressing a push button of the jog dial. The display information such as contents is then presented within the layout outline on the display of the PDA 143.

The PDA 143 has been discussed in this embodiment. The present invention is not limited to the PDA, and may also be applied to a mobile telephone.

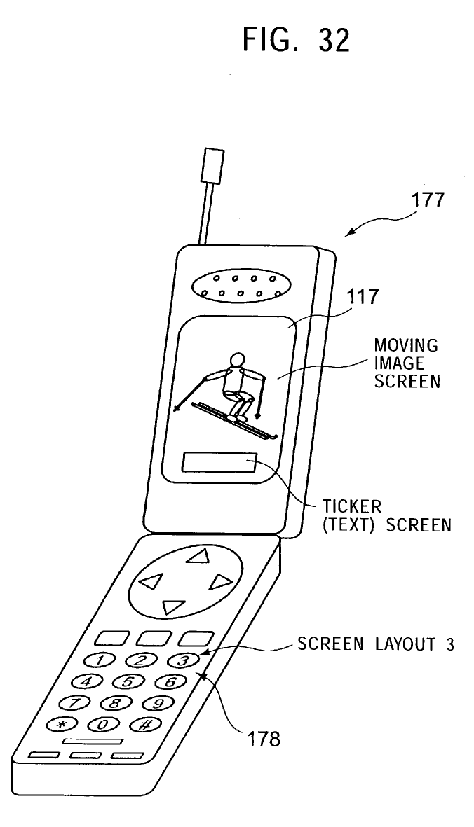

As shown in FIG. 32, a mobile telephone 177 includes numeric keys 178 corresponding to the numeric keys 173 of the remote controller 172 of the television set 101. Using the numeric keys 178, numeric information may be sent to the screen layout selector to select freely a screen layout, as in the case where the numeric keys 173 of the remote controller 172 of the television set 101 are used.

If the mobile telephone 177 has a jog dial, the screen layout having a desired content may be selected by rotating the jog dial as with the PDA 143.

In accordance with this embodiment, the display information program for laying out the screen of the PDA 143 includes descriptions of a part which defines a plurality of display areas and lays out the display areas and a part which defines an external information source at which information to be displayed in the defined display area is originated, and which allows other information attached thereto. The display information program thus defines the displaying of the information from a particular external information source. Using the rule of the URI, the information from the external information source is laid out on the display screen.

Specifically, since a scheme “videoinput” is arranged as a URI scheme, the display information for selecting the interface that exchange signals with the external information source is actively designated.

For example, if the scheme “videoinput” as a scheme of the URI is arranged and then consecutively followed by “:” and “video1” in the display information program, the video information from the camera 147 connected to the interface designated with “video1” is laid out, as is, on the display screen concurrently with or in succession to another text information as shown in FIG. 30.

Specifically, the screen layout selector 170 arranged in the controller 106 selectively calls the plurality of display information programs stored as the screen layout data in the data storage 124 again and again, and causes the description reader 138 to read the display information programs. Regardless of the type of external information, the display screen having contents laid out thereon to the user's preference is easily and freely selected.

For example, the PDA 143 presents the video information of contents laid out on the screen in response to an instruction on the recorded screen layout by rotating the jog dial 174. Rotating upwardly or downwardly the jog dial 174 successively displays the screen layouts, one after another. The video information of a desired content laid out on the screen is more easily selected than the conventional art.

The electronic apparatus such as the PDA, typically with the small information processing throughput thereof, may display the outline of each screen layout first, and thus freely presents video information of contents in a screen layout.

The present embodiment is not limited to the PDA. Alternatively, the present embodiment is applied to electronic apparatus such as a mobile telephone. Regardless of whether the display information is internally generated or is derived from an external information source, the display information is laid out on the display screen without the need for converting the display information into a file.

The electronic apparatus in accordance with a seventh embodiment of the present invention will now be discussed.

The seventh embodiment includes an information providing server arranged on a network and a terminal requesting a display information program. The transmission line of the display information program is not limited to the Internet. The transmission line may be any type, regardless of wired or wireless type, as long as the display information program is transmitted therethrough.

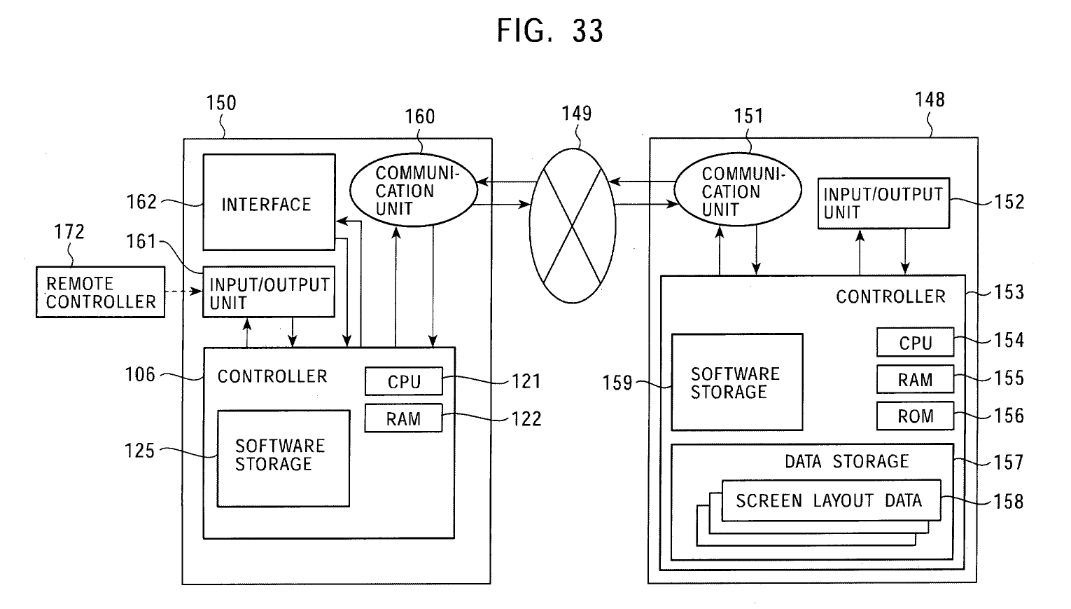

FIG. 33 is a block diagram of the server 148 which provides a display information program to a requesting terminal 150 through a network 149 in accordance with the seventh embodiment of the present invention. In FIG. 33 showing the requesting terminal, components identical to those discussed with reference to FIGS. 17 through 19 are designated with the same reference numerals, and the discussion thereof is omitted here.

As shown, the display information program providing server 148 connected to the requesting terminal 150 through the network 149 forms an information network.

The display information program providing server 148 is basically identical in construction to a content providing server, and includes a communication unit 151 for performing communication through a network 149, an input/output unit 152 such as a keyboard, display, or loudspeaker, and controller 153.

The controller 153 includes a CPU 154 for performing processes, RAM 155, ROM 156, data storage 157 for storing a variety of pieces of data, and software storage 159 for storing software programs.

The data storage 157 stores data about a program requester, and a plurality of pieces of screen layout data 158 which are display information programs produced beforehand.

The software storage 159 includes a home page presenter, program requester authenticator, data transmitter, screen layout selector, etc.

The requesting terminal 150, such as a television set, includes a communication unit 160 which performs communication over the network 149, receiver 179, display 117, input/output unit 161 with a loudspeaker, and interface 162 for exchanging information with an external information source. The requesting terminal 150 is not limited to the television set, and may be a PDA or a mobile telephone.

The operation of the display information program providing server 148 and the requesting terminal 150 is discussed below.

When URL address information of a home page is input from the requesting terminal 150 to the controller 153 of the providing server 148 through the communication unit 160, the home page presenter presents an information home page of the layout of the display screen to the requesting terminal 150 through the communication unit 151 and the network 149.

In response to the instruction of the information home page, the requester inputs information including a number selected by the remote controller 172 of the television set to the input/output unit 161. When the information is input to the controller 153 of the providing server 148 through the communication unit 160 and network 149, the data transmitter of the controller 153 reads the screen layout data 158, which is a corresponding display information program, from the data storage 157, and transmits the display information program to the controller 106 of the requesting terminal 150 through the communication unit 151 and network 149. The display information program is stored temporarily in the RAM 122 as the screen layout data 158.

Under the control of the CPU 121, the description reader reads the corresponding display information program, thereby starting reading the layout description of the program.

The description determiner of the controller 106 determines whether the read description is an XML document or an SMIL document. If it is determined that the read description is neither an XML document nor an SMIL document, an error process is performed.

If it is determined the read description is an SMIL document, the CPU 121 instructs the description determiner to parse the SMIL document. The description determiner starts decomposing the SMIL document.

The description determiner divides the segments into a part which defines and lays out a plurality of display areas, and a part which defines the external information source at which the information to be displayed in the defined display area is originated and to which other information is attached, and then checks the content of each part.

The CPU 121 checks the presence of a URI scheme defining the external information source at which the information to be displayed in the display area defined by the region component described in the display information program written in the SMIL text is originated. To this end, the description determiner extracts the “src” attributes from the basic media in the SMIL text, and determines whether “videoinput”, one of the URI schemes, is present.

If the description determiner determines that “videoinput” is present, the parameter as the display information succeeding to “videoinput” is fed to the interface selector. In response to the parameter, the interface selector selects the interface.

Display information is input to the selected interface, and the interface transfers the screen information to the controller 106. The display information is presented in the screen layout.

Video and still images from an external video input device or an external storage memory are directly laid out on the display screen without the need for converting the information into a file the electronic apparatus of the display can recognize. This operation has been difficult with the conventional SMIL document.

Subsequent to the displaying of the display information, information such as number selected in response to the operation of the remote controller 172 is input to the controller 153 of the providing server 148 through the communication unit 160 and network 149 under the control of the CPU 121. The screen layout data 158, which is a corresponding display information program, is then called. In the seventh embodiment, the providing server 148 provides the display information program to the requesting terminal 150 through the network 149 in response to a request from the requesting terminal 150 as the transmitter side. One of the URI schemes “videoinput” in a video component in the display information program provided by the providing server 148 is used so that video information such as video and game playing information input to the electronic apparatus is laid out on the display screen with layout freedom.

A plurality of display information programs stored in the data storage 157 of the providing server 148 are selectively called again and again in response to the information from the requesting terminal 150, and are then read into the description reader 138 of the requesting terminal 150. User preferred contents laid out on the display screen are freely and easily selected and displayed regardless of the type of external information.

In the seventh embodiment, no data storage 124 is arranged in the controller 106 of the requesting terminal 150. The description reader selectively reads a display information program from abundant screen layout data stored in the providing server 148 through the network 149. The controller 106 lays out screen information on the screen of the display 117 in accordance with the display information program. The electronic apparatus having the layout screen thereof becomes compact, mobile and handy, while the data storage 157 of the providing server 148 for storing the display information program provides a large storage capacity. The requesting terminal is thus provided with sophisticated functions and allows the user to customize the functions thereof.

When apparatuses having a display thereof, such as the television set 1, PDA 43, and camcorder, feature broad band capability, and are connected to a network, there is a possibility that information from a variety of media be displayed in an integrated fashion.

Demands required of the electronic apparatus may be the high level of customization such as in screen layout feature.

Taking into consideration compatibility with broadband networks, a language as open as possible must be introduced when screen layout features are incorporated.

In accordance with the present invention, a desired display is presented using an existing analog video terminal capable of merely passively receiving an electrical signal or a digital input such as an i.LINK that does not take into consideration the display position and display size of a client, when XML based SMIL is selected as a language for screen layout with compatibility with the URI maintained.

The level of customization is further heightened by embedding a parameter within the range of a format originally provided to the URI to control an apparatus.

The use of SMIL is contemplated to allow the user to view concurrently a plurality of media in a wide range of layout variations based on the apparatus such as a television, PDA, or mobile telephone rather than displaying contents using the layout and synchronization information in the SMIL supplied from a server.

The combination of these media may not be singular. A plurality of combinations serves the user more. In an apparatus having a remote controller or a jog dial, concurrently displayed layouts from the media are easily switched in the same manner as switching a television channel. The user thus enjoys convenience provided by the use of user interface. The user of the electronic apparatus receiving signals from a variety of media thus views a plurality of media in a new manner using easy-to-understand interfaces.

The present invention is not limited to any of the above-reference embodiments, and may be modified without departing from the spirit of the present invention.

For example, the display information program is produced beforehand in the above-referenced embodiments, or downloaded from the providing server 48 through the Internet. The display information program is stored in the data storage 24 as the screen layout data 26. Each time the display information program may be produced or modified based on the SMIL.

The display information program may be modified at an actual layout stage. Video information and audio information are more laid out with more layout freedom.

In the above-referenced embodiments, the television set 1 and the PDA 43 have been discussed. The preset invention is not limited to these apparatuses. The present invention may be applied to a mobile telephone. For example, a mobile telephone with a camera allows the screen thereof to be freely laid out when a picture taken by the camera is transmitted using an electronic mail together with other text information. The information communication function of the mobile telephone becomes substantially sophisticated.

In the above-referenced embodiments, the video and still image from the video input apparatus and the external storage memory are directly input to the apparatus. The present invention is not limited to this method. The present invention may work with video information or internally generated video information in a file. The video information and the internally generated video information may be freely laid out on the display screen. The level of customization is further heightened.

The present invention thus displays information from the outside world at a desired location within the screen of the display.

What is claimed is:

1. An electronic apparatus comprising:
a display for displaying an image;
an interface for inputting information from the outside world;
storage means for storing a software program in which display information, containing the information input through the interface from the outside world, to be displayed on the display, and layout information relating to a layout of each piece of information are described; and
means for causing the display to display each piece of information in accordance with the display information and the layout information described in the software program.

2. An electronic apparatus according to claim 1, comprising a plurality of the interfaces,
wherein the display information of the stored software program contains interface identification information for identifying one of the plurality of interfaces.

3. An electronic apparatus according to claim 1, wherein information input through each of a plurality of channels from the outside world is input through the interface, and
wherein the display information of the stored software program contains channel identification information for identifying one of the plurality of channels.

4. An electronic apparatus according to claim 1, wherein a plurality of types of information are input through the interface, and
wherein the display information of the stored software program contains priority information for selecting one of the plurality of types of information with priority.

5. An electronic apparatus according to claim 1, wherein the storage means stores a plurality of software programs, and
wherein the electronic apparatus comprises selector means which selects one of the plurality of software programs stored in the storage means to cause the display to display an image in accordance with the selected software program.

6. An electronic apparatus according to claim 1, further comprising selector means for selecting one of the plurality of software programs, and
wherein the storage means stores the one selected software program as a software program to be displayed.

7. An electronic apparatus comprising:
a display for displaying an image;
storage means for storing a plurality of software programs, each software program in which display information indicating information to be displayed on the display and layout information relating to a layout of each piece of information are described;
selector means for selecting one of the plurality of stored software programs; and
means causing the display to display an image responsive to the selected software program.

8. An electronic apparatus according to claim 7, wherein the display information of the stored software program contains interface identification information for identifying one of the plurality of interfaces.

9. An electronic apparatus according to claim 7, wherein information input through each of a plurality of channels from the outside world is input through the interface, and
wherein the display information of the stored software program contains channel identification information for identifying one of the plurality of channels.

10. An electronic apparatus according to claim 7, wherein a plurality of types of information are input through the interface, and
wherein the display information of the stored software program contains priority information for selecting one of the plurality of types of information with priority.

11. An electronic apparatus comprising:
a display for displaying an image;
selector means for selecting one of a plurality of software programs, each software program in which display information indicating information to be displayed on the display and layout information relating to a layout of each piece of information are described; and
means for causing the display to display an image responsive to the selected software program.

12. An electronic apparatus according to claim 11, wherein the display information of the software program contains interface identification information for identifying one of the plurality of interfaces.

13. An electronic apparatus according to claim 11, wherein information input through each of a plurality of channels from the outside world is input through the interface, and
wherein the display information of the software program contains channel identification information for identifying one of the plurality of channels.

14. An electronic apparatus according to claim 11, wherein a plurality of types of information are input through the interface, and
wherein the display information of the software program contains priority information for selecting one of the plurality of types of information with priority.

15. A software program in which, at least, first display information indicating information to be displayed on a display of an electronic apparatus and first layout information relating to each piece of information are described, the software program comprising:
a definition of second display information functioning as a trigger for selecting an interface for inputting information from outside the electronic apparatus and for displaying, on the display, the information input through the selected interface, and
a definition of second layout information relating to the information input through the interface.

16. A software program according to claim 15, wherein the second display information contains a definition of interface identification information for identifying one of the plurality of interfaces.

17. A software program according to claim 15, wherein the second display information contains a definition of channel identification information for identifying one of the plurality of channels.

18. A software program according to claim 15, wherein the second display information contains a definition of priority information for selecting one of the plurality of types of information with priority.

19. A program providing apparatus for providing a software program to a requester through a transmission line in response to a request transmitted through the transmission, the software program in which at least, first display information indicating information to be displayed on a display of an electronic apparatus and first layout information relating to each piece of information are described,
wherein the software program includes a definition of second display information functioning as a trigger for selecting an interface for inputting information from outside the electronic apparatus and for displaying, on the display, the information input through the selected interface, and
a definition of second layout information relating to the information input through the interface.

20. A storage medium storing a software program in which, at least, first display information indicating information to be displayed on a display of an electronic apparatus and first layout information relating to each piece of information are described,
wherein the software program includes a definition of second display information functioning as a trigger for selecting an interface for inputting information from outside the electronic apparatus and for displaying, on the display, the information input through the selected interface, and
a definition of second layout information relating to the information input through the interface.
